(19) United States
(12) Patent Application Publication
(10) Pub. No.: US 2007/0001112 A1
(43) Pub. Date: Jan. 4, 2007

(54) Optical element, optical pickup device, and optical information recording and/or reproducing apparatus

(75) Inventors: Tomohiro Shimoguchi, Kawaguchi-shi (JP); Yasukazu Hamano, Kawaguchi-shi (JP); Yuki Nagaoka, Fukui-shi (JP)

Correspondence Address: KODA & ANDROLIA, 2029 CENTURY PARK EAST, SUITE 1140, LOS ANGELES, CA, 90067, US

(73) Assignee: Enplas Corporation

(21) Appl. No.: 11/474,856

(22) Filed: Jun. 26, 2006

(30) Foreign Application Priority Data
Jun. 29, 2005 (JP) 2005-190518
Aug. 29, 2005 (JP) 2005-248168

(51) Int. Cl. G01J 1/04; G02B 27/40; G01D 5/38

(52) U.S. Cl. 250/237 R; 250/201.5

(57) ABSTRACT

It is to provide an optical element, an optical pickup device, and an optical information recording and/or reproducing apparatus, which can decrease the offset effectively and detect fine tracking error signals even when there is a difference between the light quantities of the two sub-beams. The first to fifth periodic structures enable generation of three beams that can provide an ideal-shaped waveform of the sum signal of two sub push-pull signals which are detected respectively from two sub-beams, whether or not there is a difference between the light quantities of the two sub-beams.

### BACKGROUND OF THE INVENTION

1. Field of the Invention

The present invention relates to an optical element, an optical pickup device, and an optical information recording and/or reproducing apparatus. Particularly, it relates to an optical element, an optical pickup device, and an optical information recording and/or reproducing apparatus, which are preferable for reducing the offset of tracking error signals.

2. Description of the Related Art

In various fields of audio, video, computer or the like, there have been conventionally employed an optical information recording apparatus and an optical information reproducing apparatus for performing recording and reproduction of information optically to/from an optical information recording medium such as an optical disk.

In such optical information recording apparatus and optical information reproducing apparatus, an optical pickup device is used for irradiating light (for example, laser beams) emitted from a light source onto a recording face of the optical information recording medium through an objective lens.

In such optical pickup device, there is performed tracking for making the light follow the track in order to irradiate the light emitted from the light source properly on the track formed on the recording face of the optical information recording medium through the objective lens.

In this tracking, the reflected light of the light spot of the light irradiated onto the recording face is detected by a photodetector (PDIC or the like) and a tracking error signal is detected by operation of the photodetector.

The position of the objective lens is corrected by a servo mechanism in accordance with the tracking error signal.

As a method for detecting the tracking error signal, there has been conventionally employed various kinds of detection methods such as DPD method, three-spot method, push-pull method, and differential push-pull method (referred to as a conventional DPP method hereinafter).

Among those methods, the conventional DPP method is particularly advantageous for decreasing the offset of the tracking error signal and performing tracking even when the objective lens is displaced in the radial direction of the optical disk during the tracking.

In the optical pickup device employing the conventional DPP method, as shown in FIG. 2 of Patent Literature 1, for example, there is disposed a diffraction grating on an optical path between a light source for emitting the laser beam and a half mirror, in order to generate three beams constituted with zero-order light (referred to as a main beam hereinafter) and ±first-order light (referred to as sub-beams hereinafter) by diffracting the light emitted from the light source.

After reflected by the half mirror, the three beams emitted from the light source are converted into parallel beams by a collimator lens and then collected by the objective lens to be irradiated as three light spots onto the recording face of the optical disk.

At this time, when the light spot of the main beam among the three light spots is irradiated onto a guide groove of the recording face as shown in FIG. 4 of Patent Literature 1, the light spots of the two sub-beams are irradiated onto two tracks at vicinal positions to the guide groove in the radial direction of the optical disk. Inversely, when the light spot of the main beam is irradiated onto the track of the recording face, the light spots of the two sub-beams are irradiated respectively on the two guide grooves at vicinal positions to the track on the inner side and outer side thereof in the radial direction of the optical disk.

This is due to the fact that the irradiation positions of each light spot are adjusted by a means, e.g. rotationally adjusting the diffraction grating with respect to the optical axis, etc.

The three beams irradiated onto the recording face of the optical disk are reflected by the recording face. At that time, for the three beams reflected by the optical disk, there is a phase difference of 180° between the reflected light of the main beam by the optical disk and the reflected light of the sub-beams by the optical disk since the irradiation positions (reflected positions) on the recording face are different from each other.

Then, the reflected light of the three beams by the optical disk reaches to the half mirror through the objective lens and the collimator lens. After transmitted through the half mirror, the reflected light makes incident on the photodetector through a detection lens.

By referring to FIG. 4 of Patent Literature 1 as a quotation, the photodetector comprises a quadripartite light receiving surface (one) constituted with four divided light receiving surfaces being divided into four by a push-pull dividing lines and a bisected light receiving surfaces (two) each constituted with two divided light receiving surfaces. The quadripartite light receiving surface corresponds to reference numeral 20a in FIG. 4 of Patent Literature 1 and the bisected light receiving surfaces correspond to reference numerals 20b, 20c in FIG. 4 of Patent Literature 1.

The reflected light of the main beam by the optical disk makes incident on the quadripartite light receiving surface and the reflected light of the two sub-beams by the optical disk makes incident on the two bisected light receiving surfaces, respectively.

When the reflected light of the three beams makes incident on each light receiving surface, detected light spots of each reflected light are formed on the respective light receiving surfaces.

These detected light spots in each light receiving surface are converted into electric signals by each divided light receiving surface.

In the above-described quadripartite light receiving surface, sum signals of the electric signals of two pairs of two divided light receiving surfaces are calculated. The sum signals are subtraction-processed by a subtractor shown by reference numeral 50a in FIG. 4 of Patent Literature 1 for detecting a push-pull signal of the main beam (referred to as a main push-pull signal hereinafter). The main push-pull signal is shown by reference numeral Sa in FIG. 4 of Patent Literature 1.

Further, in the above-described two bisected light receiving surfaces, each of the electric signals of two divided light receiving surfaces is subtraction-processed by subtractors shown by reference numerals 50b, 50c in FIG. 4 of Patent Literature 1 for detecting push-pull signals of the two sub-beams (referred to as sub push-pull signals hereinafter). The two sub push-pull signals are shown by reference numerals Sb, Sc in FIG. 4 of Patent Literature 1.

There is a phase difference of 180° (reverse phase) between the main push-pull signal and the two sub push-pull signals, because there is a phase difference of 180° between the push-pull signal waveform of the reflected light of the main beam by the optical disk and the push-pull signal waveforms of the reflected light of the sub-beams by the optical disk.

The two sub push-pull signals are converted into a sum signal through adding-processing by an adder shown by reference numeral 51 in FIG. 4 of Patent Literature 1, which is then amplified by an amplifier shown by reference numeral 52 in FIG. 4 of Patent Literature 1.

At last, subtraction processing is performed on the sum signal of the sub push-pull signals amplified by the amplifier and the main push-pull signal by a subtractor shown by reference numeral 53 in FIG. 4 of Patent Literature 1. This enables detection of the tracking error signal by the conventional DPP method as shown in FIG. 4 of Patent Literature 1.

At this time, even if there is offset of the same polarity (positive in FIG. 4 of Patent Literature 1) generated in each push-pull signal due to displacement or the like of the objective lens in the radial direction of the optical disk, there is detected a tracking error signal in which the offset component is eliminated and the signal component is amplified, since there is a phase difference of 180° between the main push-pull signal and the two sub push-pull signals.

However, the conventional DPP method described above faces such a problem that the tracking error signal cannot be detected properly when there is used an optical disk having a track pitch different from that of the optical disk shown in FIG. 4 of Patent Literature 1.

In order to solve such problem of the conventional DPP method, there has been proposed a detection method (referred to as a first-generation in-line type DPP method hereinafter) which is capable of detecting a tracking error even in the case where the main beam and the sub-beams are irradiated on the same track or on the same guide groove (see Patent Literature 2, for example).

The distinctive feature of the first-generation in-line type DPP method with respect to the conventional DPP method is that, as shown in FIG. 5 of Patent Literature 1, it employs, as the diffraction grating for generating three beams, a diffraction grating with a phase difference of 180° provided between a periodic structure constituted with protruded parts and recessed parts formed on one of substantially half surface and a periodic structure constituted with protruded parts and recessed parts formed on the other substantially half surface.

As shown in FIG. 6 of Patent Literature 1, use of such diffraction grating allows the phase difference of 180° to be provided between the main push-pull signal and the two sub push-pull signals like the conventional DPP method even in the case where the light spot of the main beam and the light spots of the two sub-beams are irradiated on the same guide groove of the optical disk.

As a result, it is possible to detect the tracking error signal like the conventional DPP method.

However, even this first-generation in-line type DPP method faces such problem of deterioration in the visual field characteristic that the amplitude of the tracking error signal decreases dramatically in accordance with the displacement amount when the objective lens is displaced in the radial direction of the optical disk.

Thus, there has been proposed a detection method (referred to as a second-generation in-line type DPP method hereinafter) for detecting a tracking error, which is aimed at solving the problem of the deterioration in the visual field while utilizing the advantages of the first-generation in-line type DPP method (see Patent Literature 1, for example).

The distinctive feature of the second-generation in-line type DPP method with respect to the first-generation in-line type DPP method is that, as shown in FIG. 27 of this Application, it employs a diffraction grating 46 divided into three areas of first to third areas 42, 43 and 45, in which the first area 42 has a periodic structure constituted of protruded parts 40 and recessed parts 41, and the second area 43 and the third area 45 sandwiching the first area 42 have a periodic structure constituted with the protruded parts 40 and the recessed parts 41.

In this diffraction grating 46, the phases of the periodic structures of the second and third areas 43, 45 differ by 90° with respect to that of the periodic structure of the first area 42, and the phase of the periodic structure of the second area 43 and that of the periodic structure of the third area 45 differ by 180° with respect to each other.

By using such diffraction grating 46, it is possible to control deterioration of the visual field even if the objective lens is displaced in the radial direction of the optical disk.
[Patent Literature 1] Japanese Unexamined Patent Publication 2004-145915
[Patent Literature 2] Japanese Unexamined Patent Publication H9-81942

However, even the second-generation in-line type DPP method as depicted in Patent Literature 1 may face distortion in the waveforms of the two push-pull signals (sub push-pull signals) detected respectively from the two sub-beams beams through the photodetector, when there is a difference between the light quantities of the two sub-beams among the three beams generated by the above-described diffraction grating 46.

This is due to the facts that there is an asymmetrical characteristic in the intensity distribution of the light emitted from the light source, the shape of the recessed part 41 or the protruded part 40 of the diffraction grating 46 is asymmetrical shape being shifted from an exact rectangular, etc.

Such deterioration in the waveforms of the push-pull signals becomes prominent particularly when performing tracking of DVD-RAM.

For example, FIG. 28 is a graph of the case where there is no difference between the light quantities of the two sub-beams, which illustrates the two sub push-pull signals detected respectively from the two sub-beams (sub +first-order PP signal and −first-order PP signal of FIG. 28) and the sum signal of those two sub push-pull signals (sum of sub ±PP signals in FIG. 28) (vertical axis) in the relation with respect to the irradiation positions of the light spots of the two sub-beams on the recording face of the optical disk (horizontal axis).

Meanwhile, FIG. 29 is a graph of the case where there is 30% difference between the light quantities of the two sub-beams, which illustrates the two sub push-pull signals detected respectively from the two sub-beams (sub +first-order PP signal and −first-order PP signal of FIG. 29) and the sum signal of those two sub push-pull signals (sum of sub ±PP signals in FIG. 29) in the relation with respect to the irradiation positions of the light spots of the two sub-beams on the recording face of the optical disk.

In the case where there is no difference between the light quantities of the two sub-beams as shown in FIG. 28, the value of the sum signal of the two push-pull signals becomes “0” when the light spots of the sub-beams are irradiated onto the groove. Meanwhile, in the case where there is a difference between the light quantities of the two sub-beams as shown in FIG. 29, the value of the sum signal of the two sub push-pull signals is shifted from “0”, thereby generating 6-7% offset.

When there is a difference between the light quantities of the two sub-beams, such offset generates whether or not there is displacement of the objective lens in the radial direction of the optical disk.

Therefore, although the second-generation in-line type DPP method described above is effective for suppressing the deterioration in the visual field characteristic when the objective lens is displaced in the radial direction of the optical disk, it is not possible to obtain securely the tracking error signal in which the offset is effectively decreased, when there is a difference between the light quantities of the two sub-beams.

### SUMMARY OF THE INVENTION

The present invention has been designed in view of such problems. It is therefore an object of the present invention to provide an optical element, an optical pickup device, and an optical information recording and/or reproducing apparatus, which can decrease the offset effectively and detect fine tracking error signals even when there is a difference in the light quantities of the two sub-beams.

In order to achieve the aforementioned objects, the optical element according to a first aspect of the present invention is an optical element for generating at least three beams by diffracting coherent light, which comprises, on at least one of surfaces in the thickness direction, a grating surface that includes at least: a first periodic structure; a second periodic structure formed at a position adjacent to the first periodic structure in one of directions orthogonal to a periodic direction of the first periodic structure in such a manner that there is a phase difference of 90° with respect to the first periodic structure; a third periodic structure formed at a position which is adjacent to the first periodic structure in the one of directions orthogonal to the periodic direction of the first periodic structure and also adjacent to the second periodic structure in the periodic direction of the first periodic structure, in such a manner that there is a phase difference of 90° with respect to the first periodic structure and a phase difference of 180° with respect to the second periodic structure; a fourth periodic structure formed at a position which is adjacent to the first periodic structure in other direction orthogonal to the periodic direction of the first periodic structure and also opposed to the second periodic structure with the first periodic structure being interposed therebetween, in such a manner that there is a phase difference of 90° with respect to the first periodic structure and a phase difference of 180° with respect to the second periodic structure; and a fifth periodic structure formed at a position adjacent to the first periodic structure in the other direction orthogonal to the periodic direction of the first periodic structure, which is opposed to the third periodic structure with the first periodic structure being interposed therebetween and also adjacent to the fourth periodic structure in the periodic direction of the first periodic structure, in such a manner that there is a phase difference of 90° with respect to the first periodic structure, a phase difference of 180° with respect to the third periodic structure, and a phase difference of 180° with respect to the fourth periodic structure.

The optical element according to a second aspect is an optical element for generating at least three beams by diffracting coherent light, which comprises, on at least one of surfaces in the thickness direction, a grating surface that includes at least: a first periodic structure; a plurality of periodic structures from second to n-th (n: a natural number of 3 or larger, same applies hereinafter) formed in order along a periodic direction of the first periodic structure to be adjacent to each other in the periodic direction of the first periodic structure at positions adjacent to the first periodic structure in one of directions orthogonal to the periodic direction of the first periodic structure, wherein all of the second to n-th periodic structures have a phase difference of 90° with respect to the first periodic structure, and phases of the periodic structures that are adjacent in the periodic direction of the first periodic structure are different from each other by 180°; and a plurality of periodic structures from (n+1)-th to (2n−1)-th formed in order along the periodic direction of the first periodic structure to be adjacent to each other in the periodic direction of the first periodic structure at positions adjacent to the first periodic structure in the other one of directions orthogonal to the periodic direction of the first periodic structure, wherein: all of the (n+1)-th to (2n−1)-th periodic structures have a phase difference of 90° with respect to the first periodic structure, and phases of the periodic structures that are adjacent in the periodic direction of the first periodic structure are different from each other by 180°; (n+k)-th periodic structure (k: a natural number between 1 and n−1, inclusive, same applies hereinafter) of the (n+1)-th to (2n−1)-th periodic structures opposes (k+1)-th periodic structure of the (n+1)-th to (2n−1)-th periodic structures with the first periodic structure being interposed therebetween; and the (n+k)-th periodic structure has a phase difference of 180° with respect to the (k+1)-th periodic structure.

The optical element according to a third aspect is the optical element of the first or second aspect, which comprises the grating surface formed on one of surfaces in thickness direction for corresponding to the first coherent light, and the grating surface formed on the other surface in the thickness direction for corresponding to the second coherent light whose wavelength is different from that of the first light.

The optical pickup device according to a fourth aspect is an optical pickup device, which comprises at least: a light source for emitting coherent light; a diffraction structure for generating three beams by diffracting light emitted from the light source; an objective lens that condenses the three beams generated by the diffraction structure for irradiating light spots of the three beams onto a recording face of an optical information recording medium; and a photodetector that receives and detects reflected light of the light spots of the three beams which are reflected by the optical information recording medium, wherein the diffraction structure comprises, on at least one of surfaces in thickness direction, a grating surface including at least: a first periodic structure; a second periodic structure formed at a position adjacent to the first periodic structure in one of directions orthogonal to a periodic direction of the first periodic structure in such a manner that there is a phase difference of 90° with respect to the first periodic structure; a third periodic structure formed at a position which is adjacent to the first periodic structure in the one of directions orthogonal to the periodic direction of the first periodic structure and also adjacent to the second periodic structure in the periodic direction of the first periodic structure, in such a manner that there is a phase difference of 90° with respect to the first periodic structure and a phase difference of 180° with respect to the second periodic structure; a fourth periodic structure formed at a position which is adjacent to the first periodic structure in the other direction orthogonal to the periodic direction of the first periodic structure and also opposed to the second periodic structure with the first periodic structure being interposed therebetween, in such a manner that there is a phase difference of 90° with respect to the first periodic structure and a phase difference of 180° with respect to the second periodic structure; and a fifth periodic structure formed at a position adjacent to the first periodic structure in the other direction orthogonal to the periodic direction of the first periodic structure, which is opposed to the third periodic structure with the first periodic structure being interposed therebetween and also adjacent to the fourth periodic structure in the periodic direction of the first periodic structure, in such a manner that there is a phase difference of 90° with respect to the first periodic structure, a phase difference of 180° with respect to the third periodic structure, and a phase difference of 180° with respect to the fourth periodic structure.

The optical pickup device according to a fifth aspect is an optical pickup device, which comprises at least: a light source for emitting coherent light; a diffraction structure for generating three beams by diffracting light emitted from the light source; an objective lens that condenses the three beams generated by the diffraction structure for irradiating light spots of the three beams onto a recording face of an optical information recording medium; and a photodetector that receives and detects reflected light of the light spots of the three beams which are reflected by the optical information recording medium, wherein the diffraction structure comprises, on at least one of surfaces in the thickness direction, a grating surface including at least: a first periodic structure; a plurality of periodic structures from second to n-th (n: a natural number of 3 or larger, same applies hereinafter) formed in order along a periodic direction of the first periodic structure to be adjacent to each other in the periodic direction of the first periodic structure at positions adjacent to the first periodic structure in one of directions orthogonal to the periodic direction of the first periodic structure, wherein all of the second to n-th periodic structures have a phase difference of 90° with respect to the first periodic structure, and phases of the periodic structures that are adjacent in the periodic direction of the first periodic structure are different from each other by 180°; and a plurality of periodic structures from (n+1)-th to (2n−1)-th formed in order along the periodic direction of the first periodic structure to be adjacent to each other in the periodic direction of the first periodic structure at positions adjacent to the first periodic structure in the other one of directions orthogonal to the periodic direction of the first periodic structure, wherein: all of the (n+1)-th to (2n−1)-th periodic structures have a phase difference of 90° with respect to the first periodic structure, and phases of the periodic structures that are adjacent in the periodic direction of the first periodic structure are different from each other by 180°; (n+k)-th periodic structure (k: a natural number between 1 and n−1, inclusive, same applies hereinafter) of the (n+1)-th to (2n−1)-th periodic structures opposes (k+1)-th periodic structure of the (n+1)-th to (2n−1)-th periodic structures with the first periodic structure being interposed therebetween; and the (n+k)-th periodic structure has a phase difference of 180° with respect to the (k+1)-th periodic structure.

The optical pickup device according to a sixth aspect is the optical pickup device of the fourth or fifth aspect, which comprises: as the light source, a plurality of light sources each emitting coherent light having a different wavelength from each other; and as the diffraction structure, a plurality of diffraction structures each having the grating surface for corresponding to the coherent light emitted from the plurality of light sources.

The optical pickup device according to a seventh aspect is the optical pickup device of the sixth aspect, wherein light spots of three beams that are generated by an arbitrary diffraction structure among the plurality of diffraction structures are irradiated onto a same track on a recording face of an optical information recording medium that corresponds to the three beams.

The optical pickup device according to an eighth aspect is the optical pickup device of the fourth or fifth aspect, wherein: the light source is formed to selectively emit coherent first light or coherent second light having a wavelength different from that of the first light; and the diffraction structure comprises the grating surface on one of surfaces in the thickness direction for corresponding to the first light, and comprises the grating surface on the other surface in the thickness direction for corresponding to the second light.

The optical pickup device according to a ninth aspect is the optical pickup device of the eighth aspect, wherein light spots of three beams that are generated by the grating surface corresponding to the first light are irradiated onto a same track on a recording face of a first optical information recording medium that corresponds to the three beams, and light spots of three beams that are generated by the grating surface corresponding to the second light are irradiated onto a same track on a recording face of a second optical information recording medium that corresponds to the three beams.

The optical information recording and/or reproducing apparatus according to a tenth aspect is an optical information recording and/or reproducing apparatus for performing at least either recording of information to an optical information recording medium or reproduction of information recorded to the optical information recording medium while controlling position of an objective lens by an objective lens position control device. The optical recording and/or reproducing apparatus comprises, at least: a light source for emitting coherent light; a diffraction structure for generating three beams by diffracting light emitted from the light source; an objective lens that condenses the three beams generated by the diffraction structure for irradiating light spots of the three beams onto a recording face of the optical information recording medium; a photodetector that receives and detects reflected light of the light spots of the three beams which are reflected by the optical information recording medium; a tracking error signal detecting device for detecting a tracking error signal based on a detected result of the photodetector; and the objective lens position control device for controlling position of the objective lens based on a detected result of the tracking error signal detecting device, wherein the diffraction structure comprises, on at least one of surfaces in the thickness direction, a grating surface including at least: a first periodic structure; a second periodic structure formed at a position adjacent to the first periodic structure in one of directions orthogonal to a periodic direction of the first periodic structure in such a manner that there is a phase difference of 90° with respect to the first periodic structure; a third periodic structure formed at a position which is adjacent to the first periodic structure in the one of directions orthogonal to the periodic direction of the first periodic structure and also adjacent to the second periodic structure in the periodic direction of the first periodic structure, in such a manner that there is a phase difference of 90° with respect to the first periodic structure and a phase difference of 180° with respect to the second periodic structure; a fourth periodic structure formed at a position which is adjacent to the first periodic structure in the other direction orthogonal to the periodic direction of the first periodic structure and also opposed to the second periodic structure with the first periodic structure being interposed therebetween, in such a manner that there is a phase difference of 90° with respect to the first periodic structure and a phase difference of 180° with respect to the second periodic structure; and a fifth periodic structure formed at a position adjacent to the first periodic structure in the other direction orthogonal to the periodic direction of the first periodic structure, which is opposed to the third periodic structure with the first periodic structure being interposed therebetween and also adjacent to the fourth periodic structure in the periodic direction of the first periodic structure, in such a manner that there is a phase difference of 90° with respect to the first periodic structure, a phase difference of 180° with respect to the third periodic structure, and a phase difference of 180° with respect to the fourth periodic structure.

The optical information recording and/or reproducing apparatus according to an eleventh aspect is an optical information recording and/or reproducing apparatus for performing at least either recording of information to an optical information recording medium or reproduction of information recorded to the optical information recording medium while controlling position of an objective lens by an objective lens position control device. The optical recording and/or reproducing apparatus comprising, at least: a light source for emitting coherent light; a diffraction structure for generating three beams by diffracting light emitted from the light source; an objective lens that condenses the three beams generated by the diffraction structure for irradiating light spots of the three beams onto a recording face of the optical information recording medium; a photodetector that receives and detects reflected light of the light spots of the three beams which are reflected by the optical information recording medium; a tracking error signal detecting device for detecting a tracking error signal based on a detected result of the photodetector; and the objective lens position control device for controlling position of the objective lens based on a detected result of the tracking error signal detecting device, wherein the diffraction structure comprises, on at least one of surfaces in thickness direction, a grating surface including at least: a first periodic structure; a plurality of periodic structures from second to n-th (n: a natural number of 3 or larger, same applies hereinafter) formed in order along the periodic direction of the first periodic structure to be adjacent to each other in the periodic direction of the first periodic structure at positions adjacent to the first periodic structure in one of directions orthogonal to the periodic direction of the first periodic structure, wherein all of the second to n-th periodic structures have a phase difference of 90° with respect to the first periodic structure, and phases of the periodic structures that are adjacent in the periodic direction of the first periodic structure are different from each other by 180°; and a plurality of periodic structures from (n+1)-th to (2n−1)-th formed in order along the periodic direction of the first periodic structure to be adjacent to each other in the periodic direction of the first periodic structure at positions adjacent to the first periodic structure in the other one of directions orthogonal to the periodic direction of the first periodic structure, wherein: all of the (n+1)-th to (2n−1)-th periodic structures have a phase difference of 90° with respect to the first periodic structure, and phases of the periodic structures that are adjacent in the periodic direction of the first periodic structure are different from each other by 180°; (n+k)-th periodic structure (k: a natural number between 1 and n−1, inclusive, same applies hereinafter) of the (n+1)-th to (2n−1)-th periodic structures opposes (k+1)-th periodic structure of the (n+1)-th to (2n−1)-th periodic structures with the first periodic structure being interposed therebetween; and the (n+k)-th periodic structure has a phase difference of 180° with respect to the (k+1)-th periodic structure.

The optical information recording and/or reproducing apparatus according to a twelfth aspect is an optical information recording and/or reproducing apparatus of the tenth or eleventh aspect, which comprises: as the light source, a plurality of light sources each emitting coherent light having a different wavelength from each other; and as the diffraction structure, a plurality of diffraction structures each having the grating surface for corresponding to the coherent light emitted from the plurality of light sources.

The optical information recording and/or reproducing apparatus according to a thirteenth aspect is an optical information recording and/or reproducing apparatus of the twelfth aspect, wherein light spots of three beams that are generated by an arbitrary diffraction structure among the plurality of diffraction structures are irradiated onto a same track on a recording face of an optical information recording medium that is used at least either for recording or reproduction of information by the three beams.

The optical information recording and/or reproducing apparatus according to a fourteenth aspect is an optical information recording and/or reproducing apparatus of the tenth or eleventh aspect, wherein: the light source is formed to selectively emit coherent first light or coherent second light having a wavelength different from that of the first light; and the diffraction structure comprises the grating surface on one of surfaces in the thickness direction for corresponding to the first light, and comprises the grating surface on the other surface in the thickness direction for corresponding to the second light.

The optical information recording and/or reproducing apparatus according to a fifteenth aspect is an optical information recording and/or reproducing apparatus of the fourteenth aspect, wherein light spots of three beams generated by the grating surface that corresponds to the first light are irradiated onto a same track on a recording face of a first optical information recording medium that is used at least either for recording or reproduction of information by the three beams, and light spots of three beams generated by the grating surface that corresponds to the second light are irradiated onto a same track on a recording face of a second optical information recording medium that is used at least either for recording or reproduction of information by the three beams.

With the optical element according to the first aspect of the present invention, the first to fifth periodic structures enable generation of three beams that can provide an ideal-shaped waveform of the sum signal of the two sub push-pull signals (referred to as a sub push-pull sum signal hereinafter) which are detected respectively from the two sub-beams, whether or not there is a difference between the light quantities of the two sub push-pull signals. As a result, it becomes possible to achieve the optical element which can decrease the offset effectively and detect fine tracking error signals even when there is a difference between the light quantities of the two sub-beams.

With the optical element according to the second aspect, the first to (2n−1)-th periodic structures enable generation of three beams that can provide an ideal-shaped waveform of the sub push-pull sum signals, whether or not there is a difference between the light quantities of the two sub push-pull signals. As a result, it is possible to achieve the optical element which can decrease the offset effectively and detect fine tracking error signals even when there is a difference between the light quantities of the two sub-beams.

With the optical element according to the third aspect, further, it is possible even in the case of using the two-wavelength light source to provide ideal-shaped waveforms of the sub push-pull sum signals that correspond respectively to the light with a different wavelength from each other, which are emitted from the two-wavelength light source. As a result, in addition to the effects of the optical pickup device according to the first or the second aspect, it becomes possible to achieve the optical element which can detect fine tracking error signals and improve the multiplicity of use even in the case of using still more kinds of optical information recording media.

Furthermore, with the optical pickup device according to the fourth aspect, it becomes possible to provide an ideal-shaped waveform of the sub push-pull sum signal through generating the three beams by the diffraction structure having the first to fifth periodic structures, whether or not there is a difference between the light quantities of the two sub push-pull signals. As a result, it is possible to achieve the optical pickup device which can decrease the offset effectively and detect fine tracking error signals even when there is a difference between the light quantities of the two sub-beams.

Further, with the optical pickup device according to the fifth aspect, it becomes possible to provide an ideal-shaped waveform of the sub push-pull sum signal through generating the three beams by the diffraction structure having the first to (2n−1)-th periodic structures, whether or not there is a difference between the light quantities of the two sub push-pull signals. As a result, it is possible to achieve the optical pickup device which can decrease the offset effectively and detect fine tracking error signals even when there is a difference between the light quantities of the two sub-beams.

With the optical pickup device according to the sixth aspect, further, it is possible even in the case of using a plurality of light sources for emitting light with a different wavelength from each other to provide ideal-shaped waveforms of the sub push-pull sum signals that correspond respectively to the light emitted from each light source. As a result, in addition to the effects of the optical pickup device according to the fourth or the fifth aspect, it becomes possible to achieve the optical element pickup device which can detect fine tracking error signals and improve the multiplicity of use even in the case of using still more kinds of optical information recording media.

Furthermore, with the optical pickup device according to the seventh aspect, it is possible even in the case of using a plurality of light sources for emitting light with a different wavelength from each other to generate three beams through diffracting the light emitted from an arbitrary light source by an arbitrary diffraction structure corresponding to that light source and to irradiate the three light spots of the three beams on the same track of the recording face of the optical information recording medium that corresponds to the three beams. The light emitted from the light sources other than the arbitrary light source can also be directed to work in the same manner on the optical information recording medium that corresponds to the respective light source. As a result, in addition to the effects of the optical pickup device according to the sixth aspect, it is possible in the case of using a plurality of light source for emitting the light with a different wavelength from each other to provide more ideal-shaped waveforms of all the sub push-pull sum signals corresponding to the respective light emitted from each light source. Thus, it becomes possible to achieve the optical pickup device which can detect fine tracking error signals and improve the multiplicity of use even in the case of using any medium out of many kinds of optical information recording media.

With the optical pickup device according to the eighth aspect, further, it is possible even in the case of using the two-wavelength light source to provide ideal-shaped waveforms of the sub push-pull sum signals that correspond respectively to the light with a different wavelength from each other, which are emitted from the two-wavelength light source. As a result, in addition to the effects of the optical pickup device according to the fourth or the fifth aspect, it becomes possible to achieve the optical element which can detect fine tracking error signals and improve the multiplicity of use even in the case of using still more kinds of optical information recording media.

With the optical pickup device according to the ninth aspect, further, it is possible when using the two-wavelength light source that selectively emits the first light or the second light to generate three beams through diffracting the first light by the grating surface that corresponds to the first light and to irradiate the three light spots of the three beams on the same track of the recording face of the first optical information recording medium. It is also possible to generate three beams through diffracting the second light by the grating surface that corresponds to the second light and to irradiate the three light spots of the three beams on the same track of the recording face of the second optical information recording medium. As a result, in addition to the effects of the optical pickup device according to the eighth aspect, it is possible in the case of using the two-wavelength light source to provide more ideal-shaped waveforms of both sub push-pull sum signals corresponding to each of the first light and the second light. Thus, it becomes possible to achieve the optical pickup device which can detect fine tracking error signals and improve the multiplicity of use in both of the cases of using either of the two kinds of the optical information recording media.

Furthermore, with the optical information recording and/or reproducing apparatus according to the tenth aspect, it becomes possible to provide an ideal-shaped waveform of the sub push-pull sum signal through generating the three beams by the diffraction structure having the first to fifth periodic structures, whether or not there is a difference between the light quantities of the two sub push-pull signals. Thus, position of the objective lens can be controlled according to the tracking error signal detected from the ideal sub push-pull sum signal. As a result, it is possible to achieve the optical information recording/reproducing apparatus which can decrease the offset effectively and detect fine tracking error signals even when there is a difference between the light quantities of the two sub-beams, thereby enabling proper recording and/or reproduction of the information to/from the optical information recording medium.

Moreover, with the optical information recording and/or reproducing apparatus according to the eleventh aspect, it becomes possible to provide an ideal-shaped waveform of the sub push-pull sum signal through generating the three beams by the diffraction structure having the first to (2n−1)-th periodic structures, whether or not there is a difference between the light quantities of the two sub push-pull signals. Thus, position of the objective lens can be controlled according to the tracking error signal detected from the ideal sub push-pull sum signal. As a result, it is possible to achieve the optical information recording/reproducing apparatus which can decrease the offset effectively and detect fine tracking error signals even when there is a difference between the light quantities of the two sub-beams, thereby enabling proper recording and/or reproduction of the information to/from the optical information recording medium.

With the optical information recording and/or reproducing apparatus according to the twelfth aspect, further, it is possible even in the case of using a plurality of light sources for emitting light with a different wavelength from each other to provide ideal-shaped waveforms of the sub push-pull sum signals that correspond respectively to the light emitted from each light source. Thus, position of the objective lens can be controlled according to the tracking error signals corresponding respectively to the light emitted from each light source, which are detected respectively from the corresponding ideal sub push-pull sum signals. As a result, in addition to the effects of the optical information recording/reproducing apparatus according to the tenth or the eleventh aspect, it becomes possible to achieve the optical information recording/reproducing apparatus which can perform proper recording and/or reproduction of the information to/from the optical information recording medium even in the case of using still more kinds of the optical information recording media.

Furthermore, with the optical information recording and/or reproducing apparatus according to the thirteenth aspect, it is possible even in the case of using a plurality of light sources for emitting light with a different wavelength from each other to generate three beams through diffracting the light emitted from an arbitrary light source by an arbitrary diffraction structure corresponding to that light source and to irradiate the three light spots of the three beams on the same track of the recording face of the optical information recording medium that corresponds to the three beams. The light emitted from the light sources other than the arbitrary light source can also be directed to work in the same manner on the optical information recording medium that corresponds to the respective light source. As a result, in addition to the effects of the optical information recording and/or reproducing apparatus according to the twelfth aspect, it is possible in the case of using a plurality of light source for emitting the light with a different wavelength from each other to provide more ideal-shaped waveforms of all the sub push-pull sum signals corresponding to the respective light emitted from each light source. Thus, it becomes possible to achieve the optical information recording/reproducing apparatus which can perform proper recording and/or reproduction of the information to/from the optical information recording medium even in the case of using any medium out of many kinds of the optical information recording media.

With the optical information recording and/or reproducing apparatus according to the fourteenth aspect, further, it is possible even in the case of using the two-wavelength light source to provide ideal-shaped waveforms of the sub push-pull sum signals that correspond respectively to the light with a different wavelength from each other, which are emitted from the two-wavelength light source. Thus, position of the objective lens can be controlled according to the tracking error signals corresponding respectively to the light emitted from each light source, which are detected respectively from the corresponding ideal sub push-pull sum signals. As a result, in addition to the effects of the optical information recording/reproducing apparatus according to the tenth or the eleventh aspect, it becomes possible to achieve the optical information recording/reproducing apparatus which can perform proper recording and/or reproduction of the information to/from the optical information recording medium even in the case of using still more kinds of the optical information recording media.

With the optical pickup device according to the ninth aspect, further, it is possible when using the two-wavelength light source that selectively emits the first light or the second light to generate three beams through diffracting the first light by the grating surface that corresponds to the first light and to irradiate the three light spots of the three beams on the same track of the recording face of the first optical information recording medium. It is also possible to generate three beams through diffracting the second light by the grating surface that corresponds to the second light and to irradiate the three light spots of the three beams on the same track of the recording face of the second optical information recording medium. As a result, in addition to the effects of the optical pickup device according to the fourteenth aspect, it is possible in the case of using the two-wavelength light source to provide more ideal-shaped waveforms of both the sub push-pull sum signals corresponding to each of the first light and the second light. Thus, it becomes possible to achieve the optical information recording and/or reproducing apparatus which can perform proper recording and/or reproduction of information for both of the two kinds of the optical information recording media.

### BRIEF DESCRIPTION OF THE DRAWINGS

FIG. 1 is a plan view for showing an embodiment of an optical element according to the present invention;

FIG. 2 is a block diagram for showing an embodiment of an optical information recording and/or reproducing apparatus according to the present invention;

FIG. 3 shows phase differences, phase distributions, and intensity distributions of +first-order sub-beam zero-order light, +fist-order sub-beam +first-order light, and +first-order sub-beam −first-order light in the embodiment of the optical information recording and/or reproducing apparatus according to the present invention;

FIG. 4 shows illustration different from FIG. 3, showing phase differences, phase distributions, and intensity distributions of +first-order sub-beam zero-order light, +fist-order sub-beam +first-order light, and +first-order sub-beam −first-order light in the embodiment of the optical information recording and/or reproducing apparatus according to the present invention;

FIG. 5 shows illustrations different from FIG. 3 and FIG. 4, showing phase differences, phase distributions, and intensity distributions of +first-order sub-beam zero-order light, +fist-order sub-beam +first-order light, and +first-order sub-beam −first-order light in the embodiment of the optical information recording and/or reproducing apparatus according to the present invention;

FIG. 6 shows illustrations different from FIG. 3-FIG. 5, showing phase differences, phase distributions, and intensity distributions of +first-order sub-beam zero-order light, +fist-order sub-beam +first-order light, and +first-order sub-beam −first-order light in the embodiment of the optical information recording and/or reproducing apparatus according to the present invention;

FIG. 7 shows phase differences, phase distributions, and intensity distributions of −first-order sub-beam zero-order light, −fist-order sub-beam +first-order light, and −first-order sub-beam −first-order light in the embodiment of the optical information recording and/or reproducing apparatus according to the present invention;

FIG. 8 shows illustrations different from FIG. 7, showing phase differences, phase distributions, and intensity distributions of −first-order sub-beam zero-order light, −fist-order sub-beam +first-order light, and −first-order sub-beam −first-order light in the embodiment of the optical information recording and/or reproducing apparatus according to the present invention;

FIG. 9 shows illustrations different from FIG. 7 and FIG. 8, showing phase differences, phase distributions, and intensity distributions of −first-order sub-beam zero-order light, −fist-order sub-beam +first-order light, and −first-order sub-beam −first-order light in the embodiment of the optical information recording and/or reproducing apparatus according to the present invention;

FIG. 10 shows illustrations different from FIG. 7-FIG. 9, showing phase differences, phase distributions, and intensity distributions of −first-order sub-beam zero-order light, −fist-order sub-beam +first-order light, and −first-order sub-beam −first-order light in the embodiment of the optical information recording and/or reproducing apparatus according to the present invention;

FIG. 11 is an illustration for showing the intensity distribution of +first-order sub-beam zero-order light, +fist-order sub-beam +first-order light, and +first-order sub-beam −first-order light in the case of using a conventional diffraction grating;

FIG. 12 is an illustration different from FIG. 11, showing the intensity distribution of +first-order sub-beam zero-order light, +fist-order sub-beam +first-order light, and +first-order sub-beam −first-order light in the case of using the conventional diffraction grating;

FIG. 13 is a graph for showing, in the case of the embodiment of the optical information recording and/or reproducing apparatus according to the present invention, a waveform of a sub push-pull sum signal when there is no difference between the light quantities of the +first-order inward sub-beam and −first-order inward sub-beam, as well as waveforms of the two sub push-pull signals;

FIG. 14 is a graph for showing, in the case of the embodiment of the optical information recording and/or reproducing apparatus according to the present invention, a waveform of a sub push-pull sum signal when there is 30% difference between the light quantities of the +first-order inward sub-beam and −first-order inward sub-beam, as well as waveforms of the two sub push-pull signals;

FIG. 15 is a plan view for showing a second embodiment of the optical element according to the present invention;

FIG. 16 is an illustration for showing the intensity distribution of the +first-order inward sub-beam in the second embodiment of the optical element according to the present invention;

FIG. 17 is an illustration different from FIG. 16, showing the intensity distribution of the +first-order inward sub-beam in the second embodiment of the optical element according to the present invention;

FIG. 18 is a plan view for showing a third embodiment of the optical element according to the present invention;

FIG. 19 is an illustration for showing the intensity distribution of the +first-order inward sub-beam in the third embodiment of the optical element according to the present invention;

FIG. 20 is an illustration different from FIG. 19, showing the intensity distribution of the +first-order inward sub-beam in the third embodiment of the optical element according to the present invention;

FIG. 21 is a block diagram for showing a second embodiment of an optical information recording and/or reproducing apparatus according to the present invention;

FIG. 22 is an illustration for schematically describing the states of detected light spots in the second embodiment of the optical information recording and/or reproducing apparatus according to the present invention;

FIG. 23 is a block diagram for showing a third embodiment of the optical information recording and/or reproducing apparatus according to the present invention;

FIG. 24 is a block diagram for showing a fourth embodiment of the optical information recording and/or reproducing apparatus according to the present invention;

FIG. 25 is a block diagram for showing a fifth embodiment of the optical information recording and/or reproducing apparatus according to the present invention;

FIG. 26 is a block diagram for showing a sixth embodiment of the optical information recording and/or reproducing apparatus according to the present invention;

FIG. 27 is a plan view for showing an example of a diffraction grating that has been conventionally used for detecting a tracking error signal;

FIG. 28 is a graph for showing, in a conventional tracking error signal detection method, a waveform of a sub push-pull sum signal when there is no difference between the light quantities of the two sub-beams, as well as waveforms of the two sub push-pull signals; and

FIG. 29 is a graph for showing, in the conventional tracking error signal detection method, a waveform of a sub push-pull sum signal when there is 30% difference between the light quantities of the two sub-beams, as well as waveforms of the two sub push-pull signals.

### DETAILED DESCRIPTION OF THE PREFERRED EMBODIMENTS

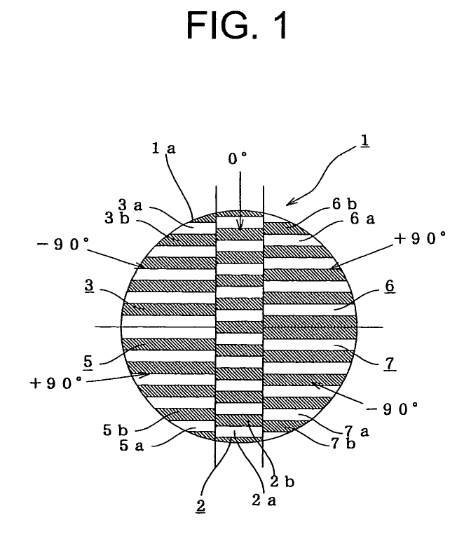

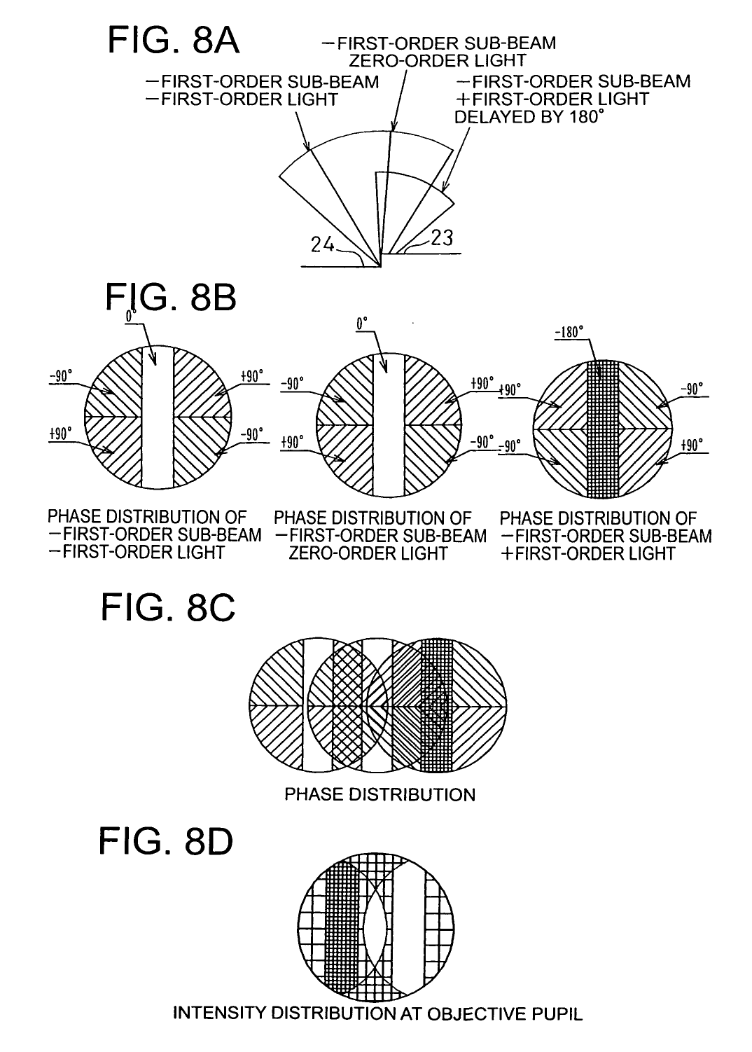

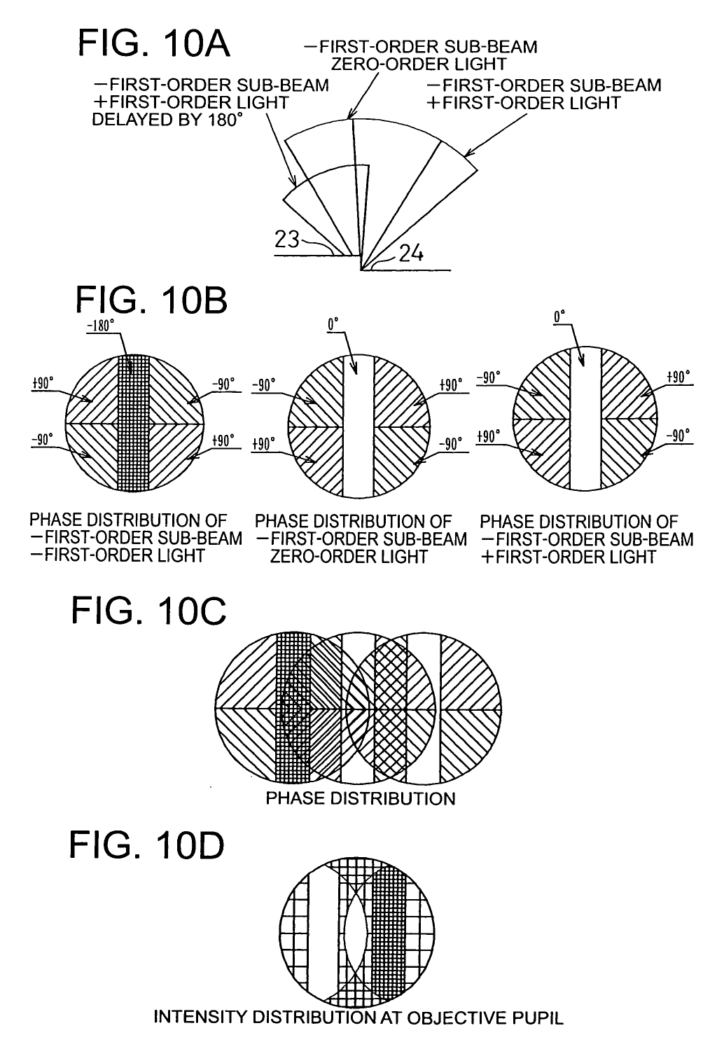

In the followings, an optical element, an optical pickup device, and an optical information recording and/or reproducing apparatus according to a first embodiment of the present invention will be described by referring to FIG. 1-FIG. 14.

### First Embodiment of Optical Element

The optical element of the first embodiment is formed to generate at least three beams by diffracting coherent light.

As shown in FIG. 1, an optical element 1 according to the embodiment has a prescribed thickness in the direction orthogonal to a paper face of FIG. 1 and comprises a grating surface 1a on the top-side surface in the thickness direction of the paper.

The grating surface 1a has a first periodic structure 2 in which a plurality of protruded parts 2a and recessed parts 2b are arranged alternately along the longitudinal direction of FIG. 1.

At a position adjacent to the first periodic structure 2 in one of the directions (in the left direction in FIG. 1) orthogonal to the periodic direction (in the longitudinal direction of FIG. 1) of the first periodic structure 2, there is formed a second periodic structure 3 having a phase difference of 90° with respect to the first periodic structure 2.

Like the first periodic structure 2, the second periodic structure 3 comprises a plurality of protruded parts 3a and recessed parts 3b arranged alternately along the longitudinal direction of FIG. 1. That is, the periodic direction of the second periodic structure 3 is formed in parallel to the periodic direction of the first periodic structure 2.

Further, the phase of the second periodic structure 3 is −90° provided that the phase of the first periodic structure 2 is 0°.

A third periodic structure 5 is formed at a position which is adjacent to the first periodic structure 2 in one of the directions orthogonal to the periodic direction of the first periodic structure 2 (in the left direction of FIG. 1) and also adjacent to the second periodic structure 3 in the periodic direction of the first periodic structure 2 (in the longitudinal direction (downward direction) of FIG. 1).

The third periodic structure 5 has a plurality of protruded parts 5a and recessed parts 5b arranged alternately along the longitudinal direction of FIG. 1. That is, the periodic direction of the third periodic structure 5 is also formed in parallel to the periodic direction of the first periodic structure 2.

Further, the third periodic structure 5 is formed with a phase difference of 90° (+90° in FIG. 1) with respect to the first periodic structure 2 and a phase difference of 180° with respect to the second periodic structure 3.

A fourth periodic structure 6 is formed at a position which is adjacent to the first periodic structure 2 in the other direction being orthogonal to the periodic direction of the first periodic structure 2 (in the right direction of FIG. 1) and also opposed to the second periodic structure 3 having the first periodic structure 2 interposed therebetween.

The fourth periodic structure 6 has a plurality of protruded parts 6a and recessed parts 6b arranged alternately along the longitudinal direction of FIG. 1. That is, the periodic direction of the fourth periodic structure 6 is also formed in parallel to the periodic direction of the first periodic structure 2.

Further, the fourth periodic structure 6 is formed with a phase difference of 90° (+90° in FIG. 1) with respect to the first periodic structure 2 and a phase difference of 180° with respect to the second periodic structure 3.

A fifth periodic structure 7 is formed at a position adjacent to the first periodic structure in the other direction being orthogonal to the periodic direction of the first periodic structure 2 (in the right direction of FIG. 1), which is also opposed to the second periodic structure 3 having the first periodic structure 2 interposed therebetween and adjacent to the fourth periodic structure 6 in the periodic direction of the first periodic structure 2 (in the longitudinal direction (downward direction) of FIG. 1).

The fifth periodic structure 7 has a plurality of protruded parts 7a and recessed parts 7b arranged alternately along the longitudinal direction of FIG. 1. That is, the periodic direction of the fifth periodic structure 7 is also formed in parallel to the periodic direction of the first periodic structure 2.

Further, the fifth periodic structure 7 is formed with a phase difference of 90° (−90° in FIG. 1) with respect to the first periodic structure 2, a phase difference of 180° with respect to the third periodic structure 5, and a phase difference of 180° with respect to the fourth periodic structure 6.

Such optical element generates three beams constituted with the main beam (zero-order light) and two sub-beams (±first-order light) by diffracting the coherent light emitted from the light source.

Hereinafter, the sub-beam of +first-order light out of the two sub-beams is referred to as the +first-order sub-beam, and the sub-beam of −first-order light is referred to as the −first-order sub-beam for the convenience sake.

### First Embodiment of Optical Pickup Device and Optical Information Recording/Reproducing Apparatus

Next, specific details of the three beams generated by such optical element 1 will be described along with the embodiment of the optical information recording/reproducing apparatus as a form of the optical information recording and/or reproducing apparatus of the present invention.

The optical information recording/reproducing apparatus of the embodiment comprises, at least: a slide mechanism capable of sliding an optical pickup device 10 in the radial direction (internal and external circumferential directions) of the optical disk; a laser lighting circuit which supplies a prescribed laser driving current to a semiconductor laser within the optical pickup device 10 for allowing the semiconductor laser to emit a prescribed quantity of laser beams; a servo signal generating circuit to which various detected servo signals are sent from the photodetector of the optical pickup device 10; an information signal reproducing circuit to which various detected information signals are sent from the photodetector of the optical pickup device 10; an actuator for driving an objective lens within the optical pickup device 10 according to the various servo signals; and an actuator driving circuit. The information signal reproducing circuit reproduces the information signals recorded on the optical disk.

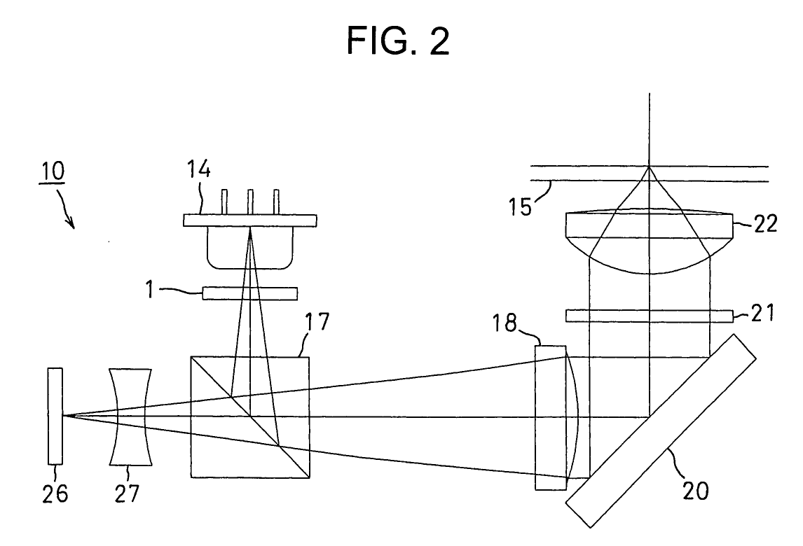

Subsequently, the optical pickup device 10 will be described in detail. Referring to a case of reproducing a DVD, the optical pickup device 10 comprises a DVD light source 14 as shown in FIG. 2. The DVD light source 14 emits coherent light with a wavelength of 660 nm by corresponding to a DVD 15 as an optical information recording medium.

The above-described optical element 1 as a diffraction structure is disposed at a position on the light emission side of the DVD light source 14, so that the light emitted from the DVD light source 14 makes incident on the optical element 1.

The optical element 1 diffracts the light making incident from the DVD light source 14 to generate the three beams (referred to as outward three beams hereinafter) which are constituted, as described above, with the main beam (referred to as an outward main beam hereinafter), the +first-order sub-beam (referred to as the +first-order outward sub-beam hereinafter), and the −first-order sub-beam (referred to as the −first-order outward sub-beam hereinafter).

A polarization beam splitter 17 is disposed at a position on the outward-three-beam emission side of the optical element 1, so that the outward three beams generated by the optical element 1 make incident on the polarization beam splitter 17.

The polarization beam splitter 17 reflects the outward three beams that make incident from the optical element 1 side.

A collimator lens 18 is disposed at a position on the outward-three-beam reflecting side of the polarization beam splitter 17, so that the outward three beams reflected by the polarization beam splitter 17 make incident on the collimator lens 18.

The collimator lens 18 emits the outward three beams that make incident from the polarization beam splitter 17 side by converting them into parallel beams.

A raising mirror 20 is disposed at a position on the outward-three-beam emission side of the collimator lens 18, so that the outward three beams emitted from the collimator lens 18 make incident on the raising mirror 20.

The raising mirror 20 reflects the outward three beams making incident from the collimator lens 18 side.

A quarter-wave plate 21 is disposed at a position on the outward-three-beam reflection side of the raising mirror 20, so that the outward three beams reflected by the raising mirror 20 make incident on the quarter-wave plate 21.

The quarter-wave plate 21 emits the outward three beams making incident from the raising mirror 20 side by converting them from the linearly polarized light into circularly polarized light.

An objective lens 22 is disposed at a position on the outward-three-beam emission side of the quarter-wave plate 21, so that the outward three beams emitted from the quarter-wave plate 21 make incident on the objective les 22.

The objective lens 22 irradiates the outward three beams making incident form the quarter-wave plate 21 side by converting them into convergent light.

Thereby, three light spots of the outward three beams are irradiated onto the recording face of the DVD 15.

When irradiated on the recording face as the light spots, the outward three beams are reflected by the recording face of the DVD 15 towards the objective lens 22 side as inward three beams.

The inward three beams are constituted with the inward main beam that is the reflected light of the outward main beam by the recording face of the DVD 15, the +first-order inward sub-beam that is the reflected light of the +first-order outward sub-beam by the recording face of the DVD 15, and the −first-order inward sub-beam that is the reflected light of the −first-order outward sub-beam by the recording face of the DVD 15.

More specifically, when the outward three beams are reflected by the recording face of the DVD 15, each of the outward main beam, the +first-order outward sub-beam and the −first-order outward sub-beam is branched into a plurality of orders of diffracted light through diffraction to be reflected towards the objection lens 22 side.

Thereby, the inward main beam of the inward three beams travels towards the objective lens 22 side as the light containing the zero-order light and the ±first-order light that are generated by the diffraction when the outward main beam is reflected by the recording face of the DVD 15.

Further, the +first-order inward sub-beam of the inward three beams travels towards the objective lens 22 side as the light containing the zero-order light (referred to as the +first-order sub-beam zero-order light hereinafter) and the ±first-order light (referred to as the +first-order sub-beam ±first-order light hereinafter) which are generated by the diffraction when the +first-order outward sub-beam is reflected by the recording face of the DVD 15.

Furthermore, the −first-order inward sub-beam of the inward three beams travels towards the objective lens 22 side as the light containing the zero-order light (referred to as the −first-order sub-beam zero-order light hereinafter) and the ±first-order light (referred to as the −first-order sub-beam ±first-order light hereinafter) which are generated by the diffraction when the −first-order outward sub-beam is reflected by the recording face of the DVD 15.

Now, the ±first-order inward sub-beam and the −first-order inward sub-beam will be described among the three inward beams, which are the essential matters of the present invention of this application.

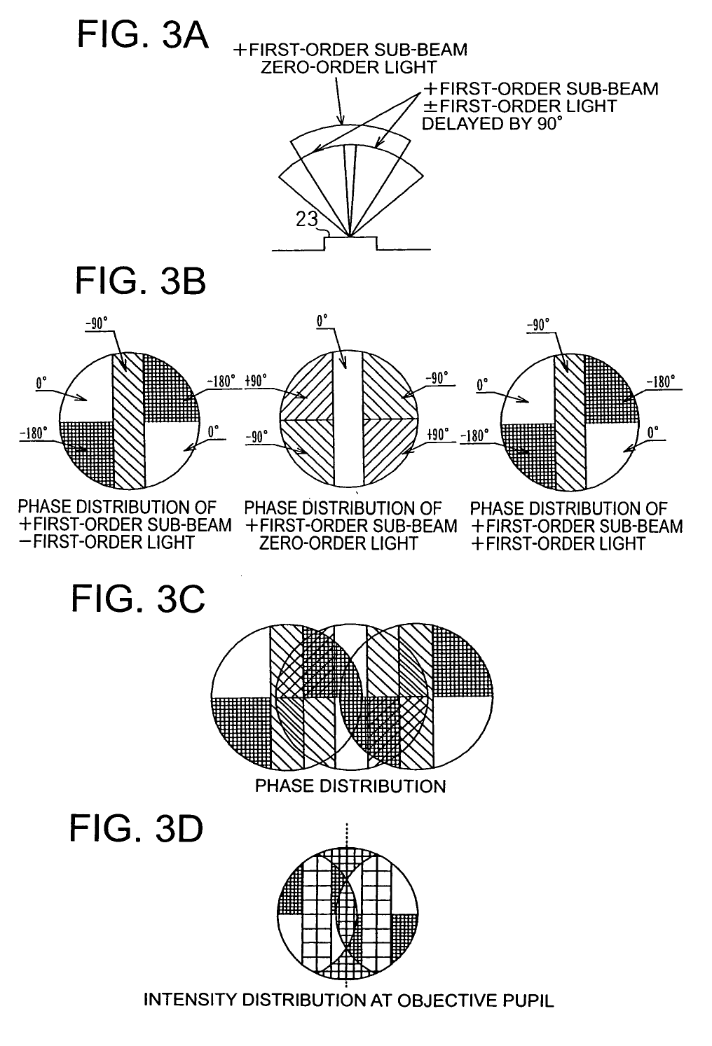

As shown in FIG. 3-FIG. 6, the +first-order sub-beam zero-order light, the +first-order sub-beam +first-order light and the +first-order sub-beam −first-order light contained in the +first-order inward sub-beam exhibit different phase differences, phase distributions, and intensity distributions in the objective lens 22 (intensity distributions at the objective pupil), depending on the reflection position of the +first-order inward sub-beam on the recording face of the DVD 15, i.e. the irradiation position of the +first-order outward sub-beam.

That is, FIG. 3A is a cross sectional view in parallel to the optical axis, which schematically illustrates the phase differences of the +first-order sub-beam zero-order light, the +first-order sub-beam +first-order light and the +first-order sub-beam −first-order light, when the light spot of the +first-order outward sub-beam is irradiated onto a land 23 on the recording face of the DVD 15. As shown in FIG. 3A, when the light spot of the +first-order outward sub-beam is irradiated onto the land 23 on the recording face of the DVD 15, the +first-order sub-beam ±first-order light has a phase delay of 90° with respect to the +first-order sub-beam zero-order light.

Further, FIG. 3B is a plan view for schematically illustrating the respective phase distributions of the +first-order sub-beam zero-order light, the +first-order sub-beam +first-order light and the +first-order sub-beam −first-order light for the case of FIG. 3A.

As can be seen from the phase distributions in FIG. 3B, each of the +first-order sub-beam zero-order light, the +first-order sub-beam +first-order light and the +first-order sub-beam −first-order light exhibits the phase distributions that are associated with the phase distributions of the first −fifth periodic structures 2, 3, 5, 6, 7 of the optical element.

As shown in FIG. 3C, the phase distributions in FIG. 3B actually take a form of the phase distributions where the phase distribution of the +first-order sub-beam +first-order light and the phase distribution of the +first-order sub-beam −first-order light partially overlap on the phase distribution of the +first-order sub-beam zero-order light.

By forming such phase distributions as shown in FIG. 3C, the intensity distribution of the +first-order inward sub-beam in the objective lens 22 becomes like the one shown in FIG. 3D, when the +first-order outward sub-beam is irradiated on the land 23 of the recording face of the DVD.

In FIG. 3D, the part with shading indicates a dark part where the intensity of light is weak, and the thicker shading indicates the darker part. Inversely, the part without shading indicates a bright part where the intensity of the light is the highest.

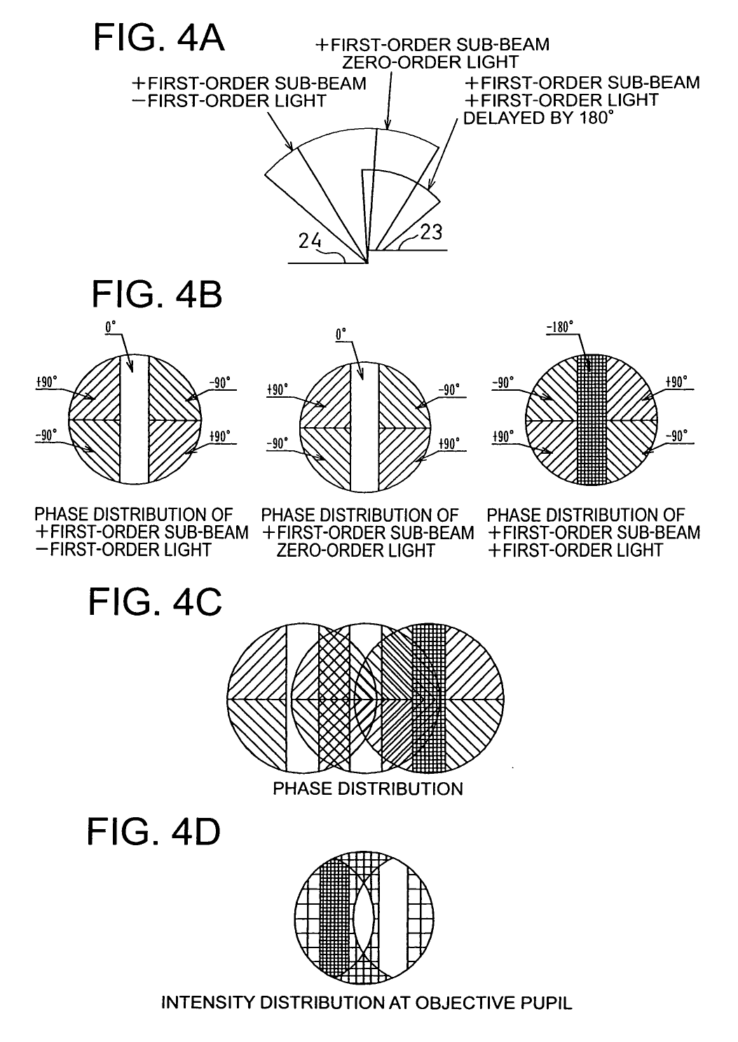

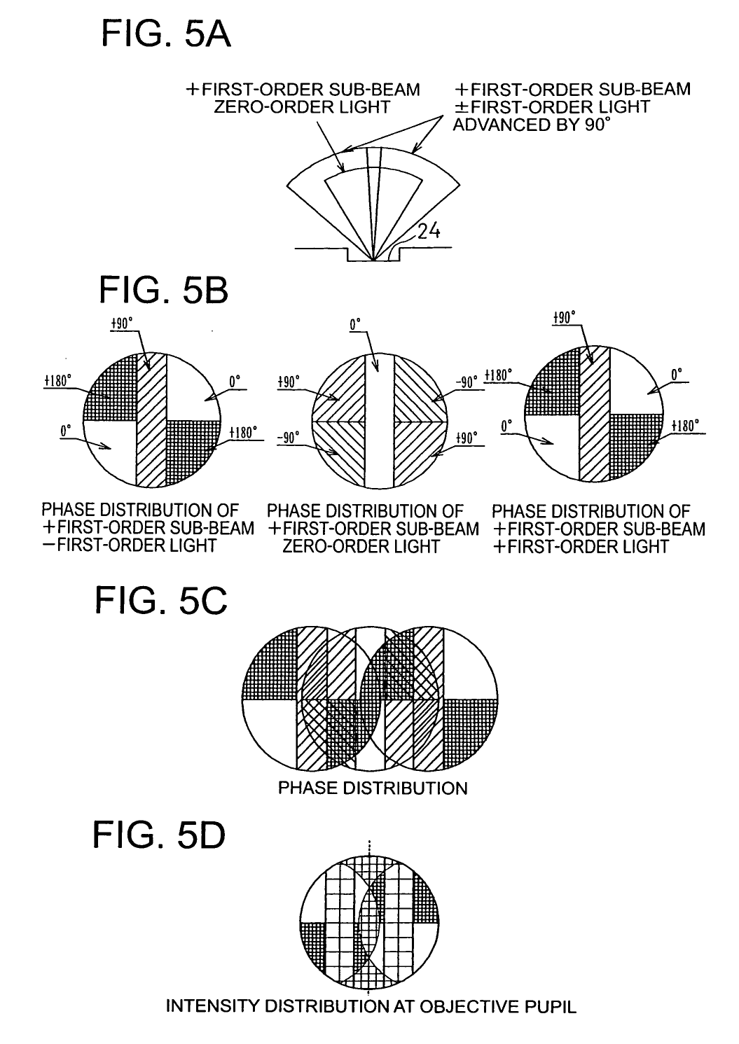

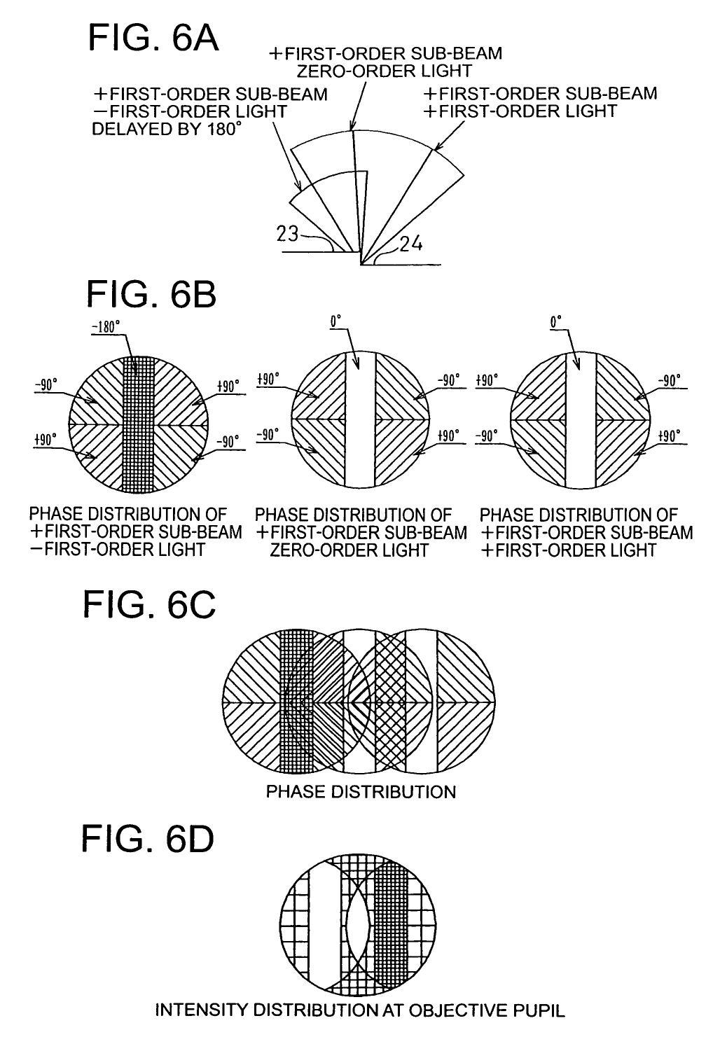

The intensity distribution in the objective pupil as shown in FIG. 3D is the same as the intensity distribution of the light spot that is detected in the light-receiving surface of a photodetector 26 as will be described later. That is, the intensity distribution of FIG, 3D indirectly indicates the waveform of the sub push-pull signal of the +first-order sub-beam (it is the same for FIG. 4D, FIG. 5D, and FIG. 6D).

For example, if the light-receiving surface of the photodetector 26 is a bisected light-receiving surface, the sub push-pull signal is a difference signal between an electric signal that is obtained when receiving light in the semicircle area on the right side of a broken line in FIG. 3D and an electric signal that is obtained when receiving light in the semicircle area on the left side of the broken line in FIG. 3D.

FIG. 4-FIG. 6 are the same as FIG. 3, illustrating the case where the irradiation positions of the +first-order sub-beams on the recording face of the DVD 15 are displaced from the state of FIG. 3A in the radial direction of the DVD 15.

That is, FIG. 4 illustrates the phase differences (FIG. 4A), the phase distributions (FIGS. 4B. and 4C), and the intensity distributions in the objective lens 22 (FIG. 4D) of the +first-order sub-beam zero-order light, the +first-order sub-beam +first-order light and the +first-order sub-beam −first-order light in the case where the +first-order outward sub-beam is irradiated onto a position on the boundary between the land 23 that is the same as the land 23 shown in FIG. 3A and a groove 24 positioned on the left side of the land 23.

Further, FIG. 5 illustrates the phase differences (FIG. 5A), the phase distributions (FIGS. 5B. and 5C), and the intensity distributions in the objective lens 22 (FIG. 5D) of the +first-order sub-beam zero-order light, the +first-order sub-beam +first-order light and the +first-order sub-beam −first-order light in the case where the +first-order outward sub-beam is irradiated onto a groove 24 that is the same as the groove 24 shown in FIG. 4A.

Furthermore, FIG. 6 illustrates the phase differences (FIG. 6A), the phase distributions (FIGS. 6B. and 6C), and the intensity distributions in the objective lens 22 (FIG. 6D) of the +first-order sub-beam zero-order light, the +first-order sub-beam +first-order light and the +first-order sub-beam −first-order light in the case where the +first-order outward sub-beam is irradiated onto a position on the boundary between the groove 24 that is the same as the groove 24 shown in FIG. 5A and the land 23 positioned on the left side of the groove 24.

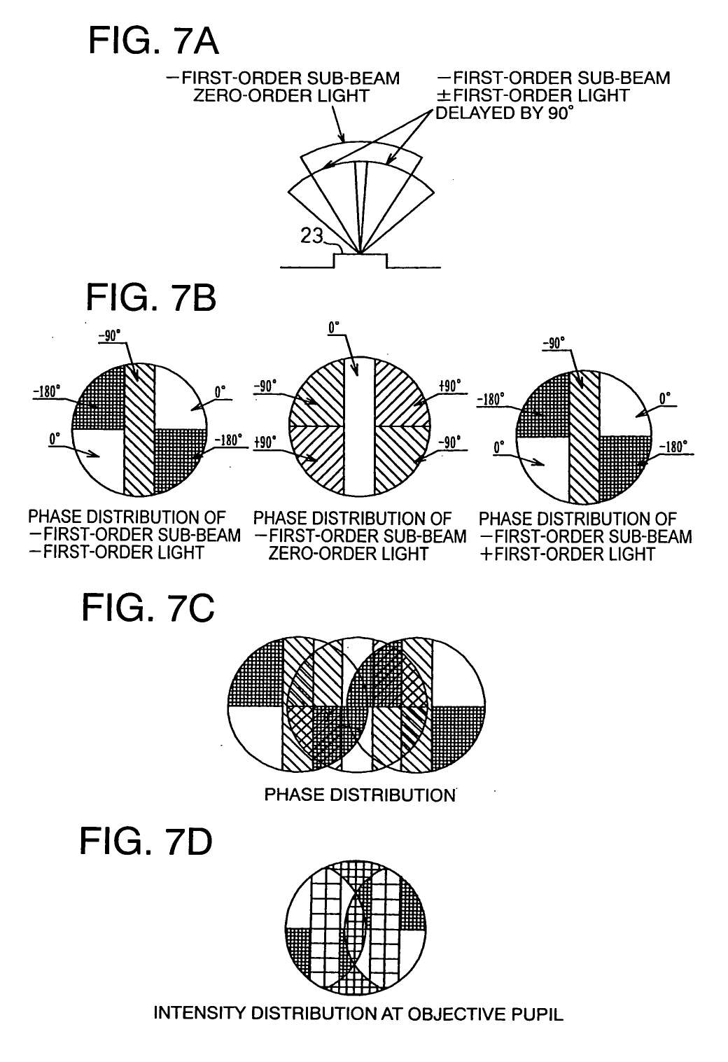

Further, as shown in FIG. 7-FIG. 10, it can be seen that the −first-order sub-beam zero-order light, the −first-order sub-beam +first-order light and the −first-order sub-beam −first-order light contained in the −first-order inward sub-beam also exhibit different phase differences, phase distributions, and intensity distributions in the objective lens 22 (intensity distributions at the objective pupil), depending on the irradiation position of the −first-order outward sub-beam on the recording face of the DVD 15.

As described above, the embodiment uses the optical element 1 comprising the first-fifth periodic structures 2, 3, 5, 6, 7 for generating the three beams (outward three beams), so that it allows the +first-order inward sub-beam to have the intensity distributions that change as in FIG. 3D-FIG. 6D in accordance with displacement of the irradiation position of the light spot of the +first-order outward sub-beam with respect to the recording face of the DVD 15. Further, the embodiment allows the −first-order inward sub-beam to have the intensity distributions that change as in FIG. 4D-FIG. 10D in accordance with displacement of the irradiation position of the light spot of the −first-order outward sub-beam with respect to the recording face of the DVD 15.

The inward three beams reflected by the recording face of the DVD 15 are converted into parallel beams by the objective lens 22 to be emitted towards the quarter-wave plate 21 side, which are then converted from the circularly polarized light into linearly polarized light by the quarter-wave plate 21 to be emitted towards the collimator lens 18 side.

The inward three beams emitted to the collimator lens 8 side are converted into convergent light by the collimator lens 18 and transmits through the polarization beam splitter 17.

A sensor lens 27 is disposed at a position on the inward-three-beam transmission side of the polarization beam splitter 17, so that the inward three beams transmitted through the polarization beam splitter 17 make incident on the sensor lens 27.

The sensor lens 27 emits the inward three beams making incident from the polarizing beam splitter 17 side by giving astigmatism thereto.

The photodetector 26 comprising three light-receiving surface is disposed at a position on the inward-three-beam emission side of the sensor lens 27, so that each of the inward main beam, the +first-order sub-beam, and the −first-order sub-beam of the inward three beams makes incident on the respective light-receiving surfaces of the photodetector 26.

On the light-receiving surface of the +first-order inward sub-beam, there is detected a detected light spot having the intensity distributions similar to those shown in FIG. 3D-FIG. 6D.

On the light-receiving surface of the −first-order inward sub-beam, there is detected a detected light spot having the intensity distributions similar to those shown in FIG. 7D-FIG. 10D.

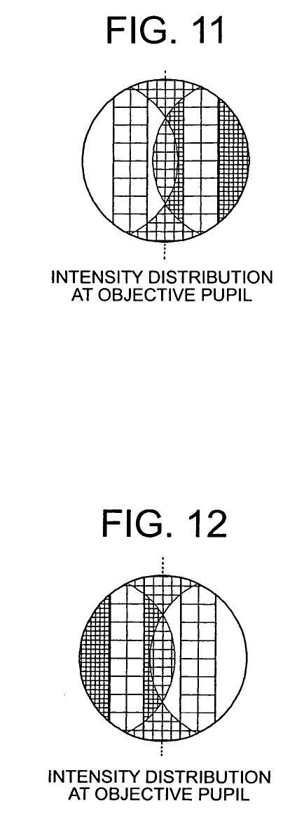

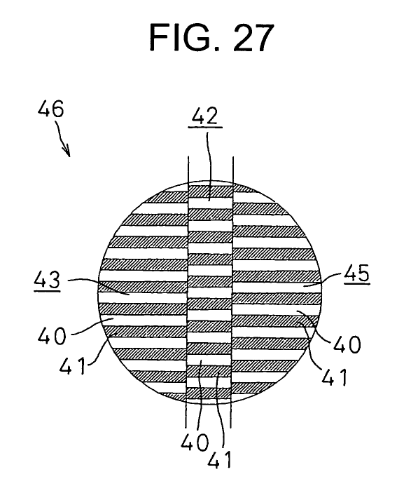

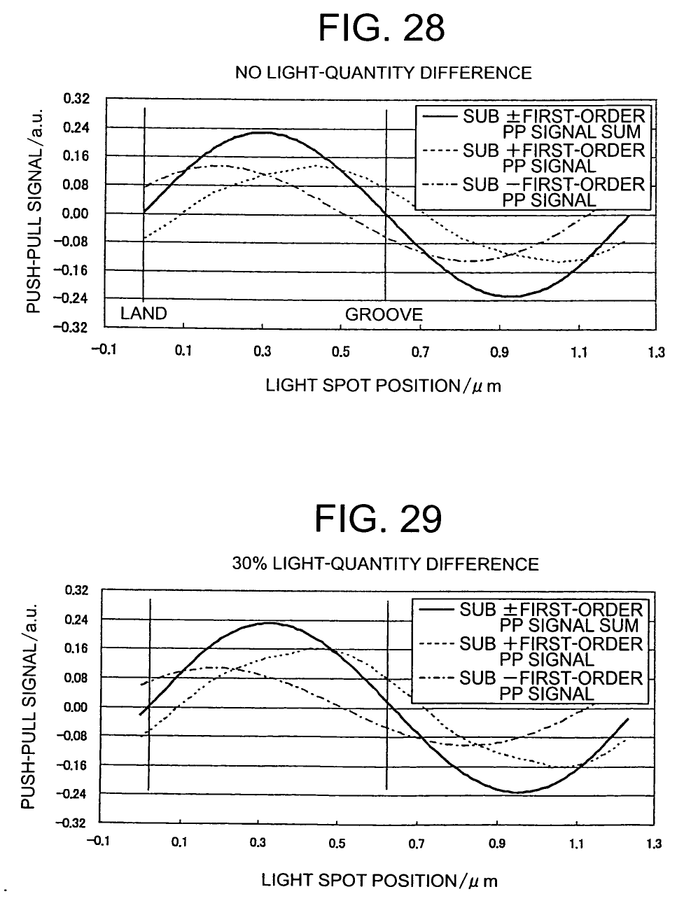

FIG. 11 shows the intensity distribution of the +first-order inward sub-beam in the objective lens 22, which is obtained when the three beams are generated by using a diffraction grating 46 (the second-generation in-line type DPP method) shown in FIG. 27 for irradiating the spot of the +first-order outward sub-beam at the same irradiation position (land 23) as that of FIG. 3A.

In order to have the ideal waveform of the sub push-pull sum signal whether or not there is a difference between the light quantities of the +first-order inward sub-beam and the −first-order inward sub-beam, it is ideal for the sub push-pull signal of the +first-order outward sub-beam to be “0” when the +first-order outward sub-beam is irradiated onto the land 23 as shown in FIG. 3A.

It has the same meaning as the fact that it is ideal for the average of the intensity distributions of the light in one area of the two semicircular areas that are virtually divided by a broken line as in FIG. 3D and FIG. 11 to be equal to the average of the intensity distributions of the light in the other area.

Comparing FIG. 3D to FIG. 11, it is clear that the embodiment as in FIG. 3D can obtain the more ideal value (0) of the sub push-pull signal of the +first-order inward sub-beam.

Further, FIG. 12 shows the intensity distribution of the +first-order inward sub-beam in the objective lens 22, which is obtained when the three beams are generated by using the diffraction grating 46 shown in FIG. 27 for irradiating the spot of the +first-order outward sub-beam at the same irradiation position (groove 24) as that of FIG. 5A.

In order to have the ideal waveform of the sub push-pull sum signal whether or not there is light-quantity difference between the +first-order inward sub-beam and the −first-order inward sub-beam, it is ideal for the sub push-pull signal of the +first-order outward sub-beam to be “0” when the +first-order outward sub-beam is irradiated onto the groove 24 as shown in FIG. 5A.

It has the same meaning as that fact that it is ideal for the average of the intensity distributions of the light in one area of the two semicircular areas that are virtually divided by a broken line as in FIG. 5D and FIG. 12 to be equal to the average of the intensity distributions of the light in the other area.

Comparing FIG. 5D to FIG. 12, it is clear that the embodiment as in FIG. 5D can obtain the more ideal value (0) of the sub push-pull signal of the +first-order inward sub-beam.

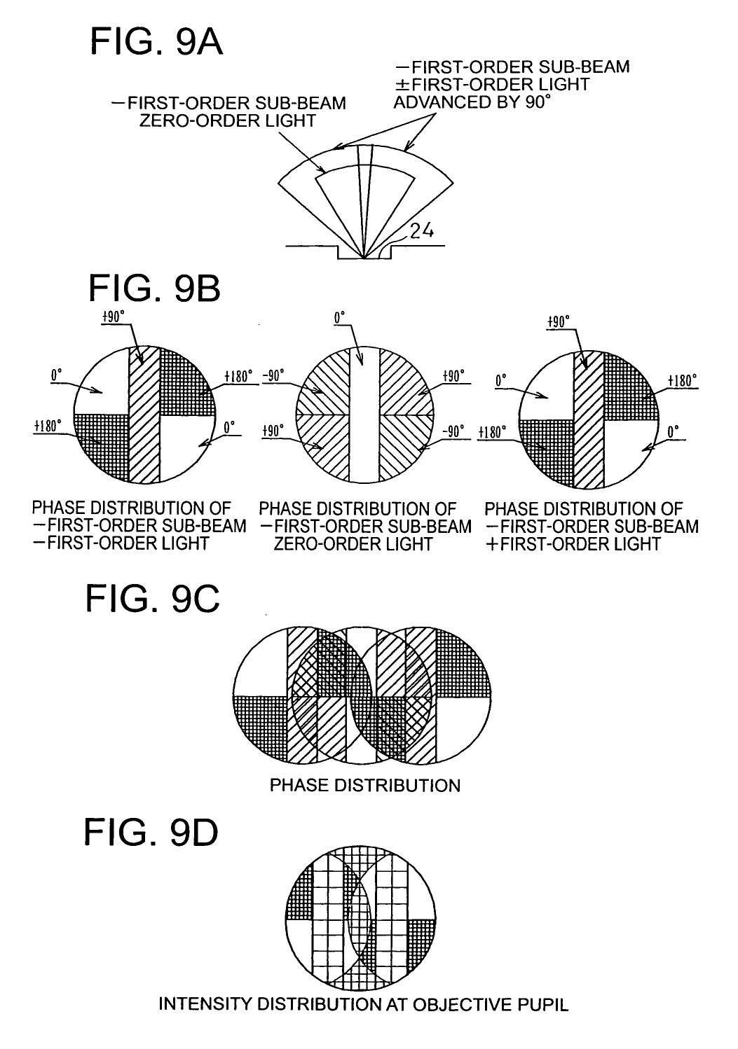

Similarly, the embodiment allows the −first-order inward sub-beam to have the intensity distributions as in FIG. 7D and FIG. 9D, so that the sub push-pull signal of the −first-order inward sub-beam can be of the ideal value (0), when the −first-order outward sub-beam is irradiated onto the land 23 or the groove 24.

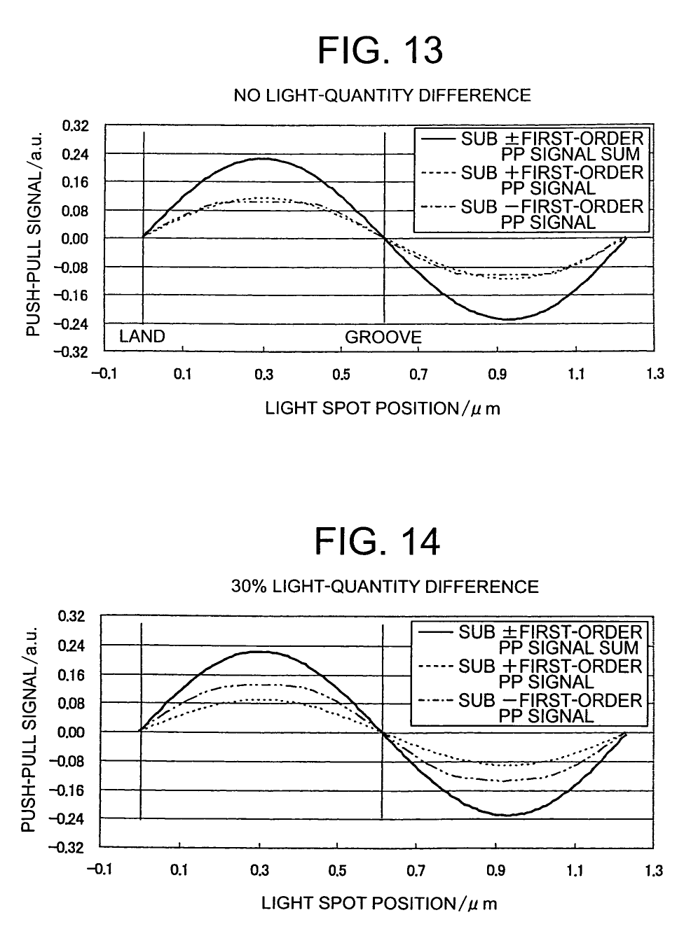

As a result, it is possible to maintain the ideal waveform of the sub push-pull sum signal (sum of the sub ±first-order PP signals in FIG. 13 and FIG. 14) not only when there is no light-quantity difference between the +first-order inward sub-beam and the −first-order inward sub-beam as in FIG. 13, but also when there is a light-quantity difference of 30% between the +first-order inward sub-beam and the −first-order inward sub-beam as in FIG. 14.

The sub +first-order PP signal of FIG. 13 and FIG. 14 is the sub-push-pull signal of the +first-order inward sub-beam, and the sub −first-order PP signal is the sub push-pull signal of the −first-order inward sub-beam. Further, the lateral axis in FIG. 13 and FIG. 14 shows the irradiation positions of the light spots of the sub +first-order outward sub-beam and the −first-order sub-beam.

By using the optical element of the present invention, it is possible to generate the tracking error signal properly by the tracking error signal circuit based on the sub push-pull sum signal having such ideal waveform. Furthermore, by controlling the position of the objective lens 22 in the radial direction of the DVD 15 through the actuator according to the tracking error signal of the tracking error signal circuit, tracking can be properly carried out. Therefore, recording can be properly performed on the recording face of the DVD 15.

As described above, with the embodiment, it is possible by using the first to fifth periodic structures 2, 3, 5, 6, 7 to generate the three beams that allow the waveform of the sub push-pull sum signal to be ideal shape, whether or not there is light-quantity difference between the +first-order inward sub-beam and the −first-order inward sub-beam.

As a result, it is possible to decrease the offset effectively even when there is light-quantity difference between the +first-order inward sub-beam and the −first-order inward sub-beam. Therefore, fine tracking error signals can be detected.

### Second Embodiment of Optical Element

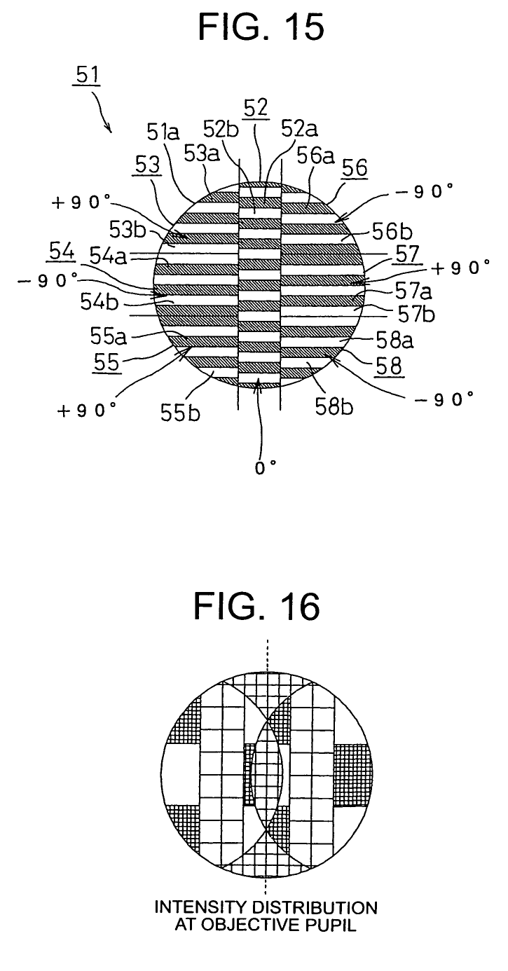

Next, a second embodiment of the optical element according to the present invention will be described by referring to FIG. 15-FIG. 17.

The same reference numerals are applied to describe the parts whose fundamental structures are identical or similar to those of the above-described optical element, the optical pickup device, and the optical information recording/reproducing apparatus of the first embodiment.

As shown in FIG. 15, like the first embodiment, an optical element 51 according to the second embodiment has a prescribed thickness in the direction orthogonal to a paper face of FIG. 15 and comprises a grating surface 51a on the top-side surface in the thickness direction of the paper.

The grating surface 51a has a first periodic structure 52 in which a plurality of protruded parts 52a and recessed parts 52b are arranged alternately along the longitudinal direction of FIG. 15.

At a position adjacent to the first periodic structure 52 in one of the directions (in the left direction in FIG. 15) orthogonal to the periodic direction (in the longitudinal direction of FIG. 15) of the first periodic structure 52, there is formed a second periodic structure 53 having a phase difference of 90° with respect to the first periodic structure 52.

Like the first periodic structure 52, the second periodic structure 53 comprises a plurality of protruded parts 53a and recessed parts 53b arranged alternately along the longitudinal direction of FIG. 15. That is, the periodic direction of the second periodic structure 53 is formed in parallel to the periodic direction of the first periodic structure 52.

Further, the phase of the second periodic structure 53 is +90° provided that the phase of the first periodic structure 52 is 0°.

A third periodic structure 54 is formed at a position which is adjacent to the first periodic structure 52 in one of the directions orthogonal to the periodic direction of the first periodic structure 52 (in the left direction of FIG. 15) and also adjacent to the second periodic structure 53 in the periodic direction of the first periodic structure 52 (in the longitudinal direction (downward direction) of FIG. 15).

The third periodic structure 54 has a plurality of protruded parts 54a and recessed parts 54b arranged alternately along the longitudinal direction of FIG. 15. That is, the periodic direction of the third periodic structure 54 is also formed in parallel to the periodic direction of the first periodic structure 52.

Further, the third periodic structure 54 is formed with a phase difference of 90° (−90° in FIG. 15) with respect to the first periodic structure 52 and a phase difference of 180° with respect to the second periodic structure 53.

A fourth periodic structure 55 is formed at a position which is adjacent to the first periodic structure 52 in the other direction being orthogonal to the periodic direction of the first periodic structure 52 (in the left direction of FIG. 15) and also adjacent to the third periodic structure 54 in the periodic direction of the first periodic structure 52 (in the longitudinal direction (downward direction) of FIG. 15).

The fourth periodic structure 55 has a plurality of protruded parts 55a and recessed parts 55b arranged alternately along the longitudinal direction of FIG. 15. That is, the periodic direction of the fourth periodic structure 55 is also formed in parallel to the periodic direction of the first periodic structure 52.

Further, the fourth periodic structure 55 is formed with a phase difference of 90° (+90° in FIG. 15) with respect to the first periodic structure 52 and a phase difference of 180° with respect to the third periodic structure 54.

A fifth periodic structure 56 is formed at a position which is adjacent to the first periodic structure 52 in the other direction being orthogonal to the periodic direction of the first periodic structure 52 (in the right direction of FIG 15) and also opposed to the second periodic structure 53 having the first periodic structure 52 interposed therebetween.

The fifth periodic structure 56 has a plurality of protruded parts 56a and recessed parts 56b arranged alternately along the longitudinal direction of FIG. 15. That is, the periodic direction of the fifth periodic structure 56 is also formed in parallel to the periodic direction of the first periodic structure 52.

Further, the fifth periodic structure 56 is formed with a phase difference of 90° (−90° in FIG. 1) with respect to the first periodic structure 52 and a phase difference of 180° with respect to the second periodic structure 53.

Furthermore, a sixth periodic structure 57 is formed at a position adjacent to the first periodic structure 52 in the other direction being orthogonal to the periodic direction of the first periodic structure 52 (in the right direction of FIG. 15), which is opposed to the third periodic structure 54 having the first periodic structure 52 interposed therebetween, and also adjacent to the fifth periodic structure 56 in the periodic direction of the first periodic structure 52 (in the longitudinal direction (downward direction) of FIG. 15).

The sixth periodic structure 57 has a plurality of protruded parts 57a and recessed parts 57b arranged alternately along the longitudinal direction of FIG. 15. That is, the periodic direction of the sixth periodic structure 57 is also formed in parallel to the periodic direction of the first periodic structure 52.

Further, the sixth periodic structure 57 is formed with a phase difference of 90° (+90° in FIG. 15) with respect to the first periodic structure 52, a phase difference of 180° with respect to the third periodic structure 54, and a phase difference of 180° with respect to the fifth periodic structure 56.

A seventh periodic structure 58 is formed at a position adjacent to the first periodic structure 52 in the other direction being orthogonal to the periodic direction of the first periodic structure 52 (in the right direction of FIG. 15), which is opposed to the fourth periodic structure 55 having the first periodic structure 52 interposed therebetween, and also adjacent to the sixth periodic structure 57 in the periodic direction of the first periodic structure 52 (in the longitudinal direction (downward direction) of FIG. 15).

The seventh periodic structure 58 has a plurality of protruded parts 58a and recessed parts 58b arranged alternately along the longitudinal direction of FIG. 15. That is, the periodic direction of the seventh periodic structure 58 is also formed in parallel to the periodic direction of the first periodic structure 52.

Further, the seventh periodic structure 58 is formed with a phase difference of 90° (−90° in FIG. 15) with respect to the first periodic structure 52, a phase difference of 180° with respect to the fourth periodic structure 55, and a phase difference of 180° with respect to the sixth periodic structure 57.

Like the optical element 1 of the first embodiment, the optical element 51 of the second embodiment having such configuration is disposed at the light-emission side of a DVD light source 14 shown in FIG. 2 for diffracting the light making incident from the DVD light source 14 side to generate the outward three beams constituted with, as described above, the outward main beam, the +first-order outward sub-beam, and the −first-order outward sub-beam.

The outward three beams are reflected and converted to the inward three beams by the recording face of the DVD 15 through the same optical path as that of the first embodiment.

Among the inward three beams, the +first-order inward sub-beam that is the reflected light of the +first-order outward sub-beam by the recording face of the DVD 15 exhibits the intensity distribution (intensity distribution at the objective pupil) in the objective lens 22 as in FIG. 16, when the +first-order outward sub-beam is irradiated onto the land 23 of the recording face of the DVD 15.

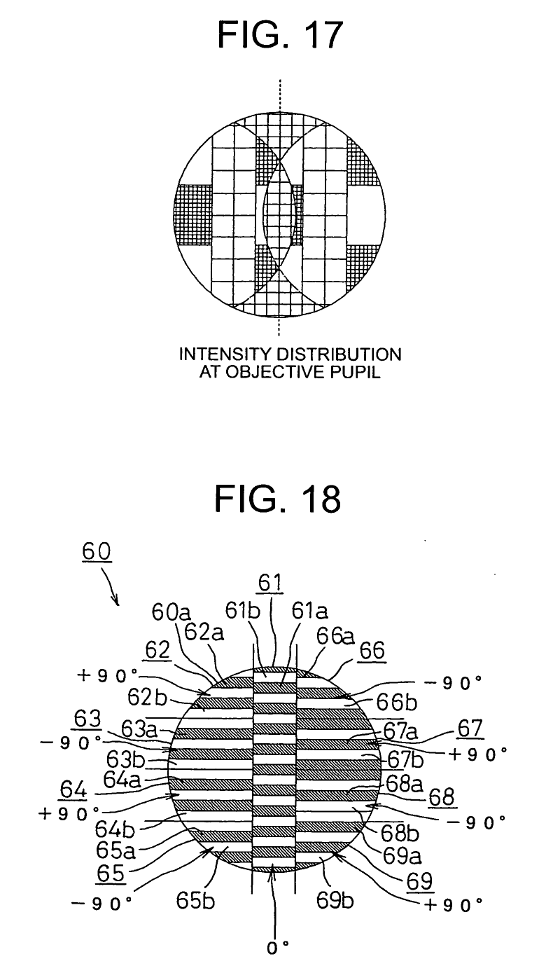

Further, the +first-order inward sub-beam exhibits the intensity distribution (intensity distribution at the objective pupil) in the objective lens 22 as in FIG. 17, when the +first-order outward sub-beam is irradiated onto the groove 24 on the recording face of the DVD 15.

Like the intensity distribution shown in FIG. 3D, for the intensity distributions shown in FIG. 16, the average of the intensity distributions of the light in one area of the two semicircular areas that are virtually divided by a broken line in FIG. 16 is equal to the average of the intensity distributions of the light in the other area.

Further, like the intensity distribution shown in FIG. 5D, for the intensity distributions shown in FIG. 17, the average of the intensity distributions of the light in one area of the two semicircular areas that are virtually divided by a broken line in FIG. 17 is equal to the average of the intensity distributions of the light in the other area.

This indicates that the optical element 51 of this embodiment is capable of obtaining the ideal value (0) of the sub push-pull signal of the +first-order inward sub-beam like the optical element 1 of the first embodiment. Furthermore, although not shown, it is possible to obtain the ideal value of sub push-pull signal of the −first-order inward sub-beam like that of the +first-order inward sub-beam.

Therefore, like the first embodiment, the optical element 51 of the second embodiment can also generate the there beams that allow the waveform of the sub push-pull sum signal to be ideal shape, whether or not there is light-quantity difference between the +first-order inward sub-beam and the −first-order inward sub-beam.

### Third Embodiment of Optical Element

Next, a third embodiment of the optical element according to the present invention will be described by referring to FIG. 18-FIG. 20.

Like the second embodiment, the same reference numerals are also applied in the third embodiment to describe the parts whose fundamental structures are identical or similar to those of the above-described optical element, the optical pickup device, and the optical information recording/reproducing apparatus of the first embodiment.

As shown in FIG. 18, like the first embodiment, an optical element 60 according to the third embodiment has a prescribed thickness in the direction orthogonal to a paper face of FIG. 18 and comprises a grating surface 60a on the top-side surface in the thickness direction of the paper.

The grating surface 60a has a first periodic structure 61 in which a plurality of protruded parts 61a and recessed parts 61b are arranged alternately along the longitudinal direction of FIG. 18.

At a position adjacent to the first periodic structure 61 in one of the directions (in the left direction in FIG. 18) orthogonal to the periodic direction (in the longitudinal direction of FIG. 18) of the first periodic structure 61, there is formed a second periodic structure 62 having a phase difference of 90° with respect to the first periodic structure 61.

Like the first periodic structure 61, the second periodic structure 62 comprises a plurality of protruded parts 62a and recessed parts 62b arranged alternately along the longitudinal direction of FIG. 18. That is, the periodic direction of the second periodic structure 62 is formed in parallel to the periodic direction of the first periodic structure 61.

Further, the phase of the second periodic structure 62 is +90° provided that the phase of the first periodic structure 61 is 0°.

A third periodic structure 63 is formed at a position which is adjacent to the first periodic structure 61 in one of the directions orthogonal to the periodic direction of the first periodic structure 61 (in the left direction of FIG. 18) and also adjacent to the second periodic structure 62 in the periodic direction of the first periodic structure 61 (in the longitudinal direction (downward direction) of FIG. 18).

The third periodic structure 63 has a plurality of protruded parts 63a and recessed parts 63b arranged alternately along the longitudinal direction of FIG. 18. That is, the periodic direction of the third periodic structure 63 is also formed in parallel to the periodic direction of the first periodic structure 61.

Further, the third periodic structure 63 is formed with a phase difference of 90° (−90° in FIG. 18) with respect to the first periodic structure 61 and a phase difference of 180° with respect to the second periodic structure 62.

A fourth periodic structure 64 is formed at a position which is adjacent to the first periodic structure 61 in the other direction being orthogonal to the periodic direction of the first periodic structure 61 (in the left direction of FIG. 18) and also adjacent to the third periodic structure 63 in the periodic direction of the first periodic structure 61 (in the longitudinal direction (downward direction) of FIG. 18).

The fourth periodic structure 64 has a plurality of protruded parts 64a and recessed parts 64b arranged alternately along the longitudinal direction of FIG. 18. That is, the periodic direction of the fourth periodic structure 64 is also formed in parallel to the periodic direction of the first periodic structure 61.

Further, the fourth periodic structure 64 is formed with a phase difference of 90° (+90° in FIG. 18) with respect to the first periodic structure 61 and a phase difference of 180° with respect to the third periodic structure 63.

A fifth periodic structure 65 is formed at a position adjacent to the first periodic structure 61 in the other direction being orthogonal to the periodic direction of the first periodic structure 61 (in the left direction of FIG. 15) and also adjacent to the fourth periodic structure 64 in the periodic direction of the first periodic structure 61 (in the longitudinal direction (downward direction) of FIG. 18).

The fifth periodic structure 65 has a plurality of protruded parts 65a and recessed parts 66b arranged alternately along the longitudinal direction of FIG. 18. That is, the periodic direction of the fifth periodic structure 65 is also formed in parallel to the periodic direction of the first periodic structure 61.

Further, the fifth periodic structure 65 is formed with a phase difference of 90° (−90° in FIG. 1) with respect to the first periodic structure 61 and a phase difference of 180° with respect to the fourth periodic structure 64.

Furthermore, a sixth periodic structure 66 is formed at a position which is adjacent to the first periodic structure 61 in the other direction being orthogonal to the periodic direction of the first periodic structure 61 (in the right direction of FIG. 18) and also opposed to the second periodic structure 62 having the first periodic structure 61 interposed therebetween.

The sixth periodic structure 66 has a plurality of protruded parts 66a and recessed parts 66b arranged alternately along the longitudinal direction of FIG. 18. That is, the periodic direction of the sixth periodic structure 66 is also formed in parallel to the periodic direction of the first periodic structure 61.

Further, the sixth periodic structure 66 is formed with a phase difference of 90° (−90° in FIG. 18) with respect to the first periodic structure 61 and a phase difference of 180° with respect to the second periodic structure 62.

A seventh periodic structure 67 is formed at a position adjacent to the first periodic structure 61 in the other direction being orthogonal to the periodic direction of the first periodic structure 61 (in the right direction of FIG. 18), which is opposed to the third periodic structure 63 having the first periodic structure 61 interposed therebetween, and also adjacent to the sixth periodic structure 66 in the periodic direction of the first periodic structure 61 (in the longitudinal direction (downward direction) of FIG. 18).

The seventh periodic structure 67 has a plurality of protruded parts 67a and recessed parts 67b arranged alternately along the longitudinal direction of FIG. 18. That is, the periodic direction of the seventh periodic structure 67 is also formed in parallel to the periodic direction of the first periodic structure 61.

Further, the seventh periodic structure 67 is formed with a phase difference of 90° (+90° in FIG. 18) with respect to the first periodic structure 61, a phase difference of 180° with respect to the third periodic structure 63, and a phase difference of 180° with respect to the sixth periodic structure 66.

An eighth periodic structure 68 is formed at a position adjacent to the first periodic structure 61 in the other direction being orthogonal to the periodic direction of the first periodic structure 61 (in the right direction of FIG. 18), which is opposed to the fourth periodic structure 64 having the first periodic structure 61 interposed therebetween, and also adjacent to the seventh periodic structure 67 in the periodic direction of the first periodic structure 61 (in the longitudinal direction (downward direction) of FIG. 18).

The eighth periodic structure 68 has a plurality of protruded parts 68a and recessed parts 68b arranged alternately along the longitudinal direction of FIG. 18. That is, the periodic direction of the eighth periodic structure 68 is also formed in parallel to the periodic direction of the first periodic structure 61.

Further, the eighth periodic structure 68 is formed with a phase difference of 90° (−90° in FIG. 18) with respect to the first periodic structure 61, a phase difference of 180° with respect to the fourth periodic structure 64, and a phase difference of 180° with respect to the seventh periodic structure 67.

A ninth periodic structure 69 is formed at a position adjacent to the first periodic structure in the other direction being orthogonal to the periodic direction of the first periodic structure 61 (in the right direction of FIG. 18), which is opposed to the fifth periodic structure 65 having the first periodic structure 61 interposed therebetween, and also adjacent to the eighth periodic structure 68 in the periodic direction of the first periodic structure 61 (in the longitudinal direction (downward direction) of FIG. 18).

The ninth periodic structure 69 has a plurality of protruded parts 69a and recessed parts 69b arranged alternately along the longitudinal direction of FIG. 18. That is, the periodic direction of the ninth periodic structure 69 is also formed in parallel to the periodic direction of the first periodic structure 61.

Further, the ninth periodic structure 69 is formed with a phase difference of 90° (+90° in FIG. 18) with respect to the first periodic structure 61, a phase difference of 180° with respect to the fifth periodic structure 65, and a phase difference of 180° with respect to the eighth periodic structure 68.

Like the optical element 1 of the first embodiment, the optical element 60 of the third embodiment having such configuration is disposed at the light-emission side of the DVD light source 14 shown in FIG. 2 for diffracting the light making incident from the DVD light source 14 side to generate the outward three beams constituted with, as described above, the outward main beam, the +first-order outward sub-beam, and the −first-order outward sub-beam.

The outward three beams are reflected and converted to the inward three beams by the recording face of the DVD 15 through the same optical path as that of the first embodiment.

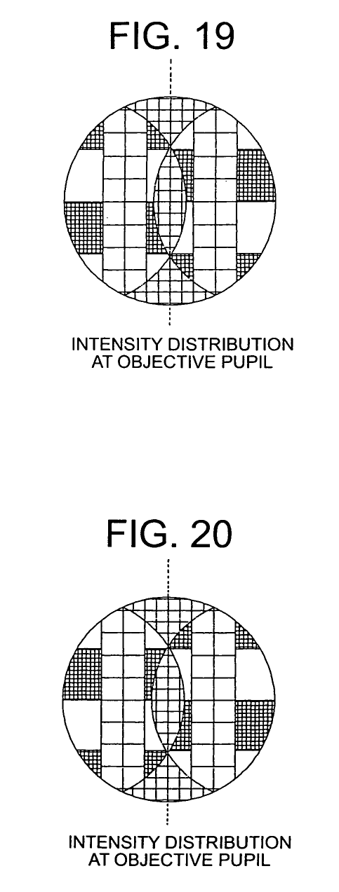

Among the inward three beams, the +first-order inward sub-beam that is the reflected light of the +first-order outward sub-beam by the recording face of the DVD 15 exhibits the intensity distribution (intensity distribution at the objective pupil) in the objective lens 22 as in FIG. 19, when the +first-order outward sub-beam is irradiated onto the land 23 on the recording face of the DVD 15.

Further, the +first-order inward sub-beam exhibits the intensity distribution (intensity distribution at the objective pupil) in the objective lens 22 as in FIG. 20, when the +first-order outward sub-beam is irradiated onto the groove 24 on the recording face of the DVD 15.

Like the intensity distribution shown in FIG. 3D, for the intensity distributions shown in FIG. 19, the average of the intensity distributions of the light in one area of the two semicircular areas that are virtually divided by a broken line in FIG. 19 is equal to the average of the intensity distributions of the light in the other area.

Furthermore, like the intensity distribution shown in FIG. 5D, for the intensity distributions shown in FIG. 20, the average of the intensity distributions of the light in one area of the two semicircular areas that are virtually divided by a broken line in FIG. 20 is equal to the average of the intensity distributions of the light in the other area.

This indicates that the optical element 60 of this embodiment is capable of obtaining the ideal value (0) of the sub push-pull signal of the +first-order inward sub-beam like the optical element 1 of the first embodiment. Furthermore, although not shown, it is possible to obtain the ideal value of sub push-pull signal of the −first-order inward sub-beam like that of the +first-order inward sub-beam.

Therefore, like the first and second embodiments, the optical element 60 of the third embodiment can also generate the three beams that allow the waveform of the sub push-pull sum signal to be ideal shape, whether or not there is light-quantity difference between the +first-order inward sub-beam and the −first-order inward sub-beam.

### Second Embodiment of Optical Pickup Device and Optical Information Recording/Reproducing Apparatus

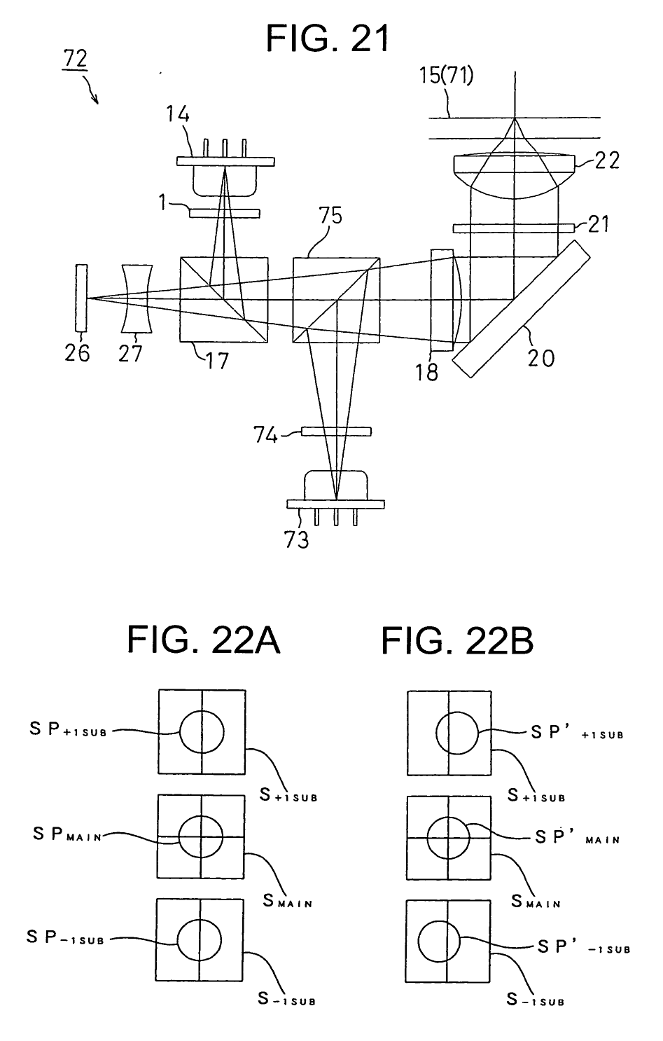

Next, a second embodiment of the optical pickup device and the optical information recording/reproducing apparatus will be described by referring to FIG. 21 and FIG. 22, emphasizing on the difference with respect to the first embodiment.

The same reference numerals are used to describe the parts whose fundamental structures are identical or similar to those of the first embodiment.

In addition to the structure of the optical information recording/reproducing apparatus of the first embodiment, the optical information recording/reproducing apparatus according to the second embodiment is also capable of performing at least either recording or reproduction of information to/from a CD 71 used as an optical information recording medium.

That is, as shown in FIG. 21, an optical pickup device 72 of the optical information recording/reproducing apparatus according to this embodiment comprises a CD light source 73 in addition to the structure of the optical pickup device 10 of the first embodiment. The CD light source 73 emits coherent light with the wavelength of 780 nm for corresponding to the CD 71.

At a position on the light emission side of the CD light source 73, there is disposed, as a diffraction structure, a typical (well-known) diffraction grating 74 with a single periodic structure (not shown) that corresponds not to the in-line DPP method according to the present invention but to a regular DPP method. Light emitted from the CD light source 73 makes incident on the diffraction grating 74.

The diffraction grating 74 diffracts the light making incident from the CD light source 73 to generate the three beams (referred to as CD outward three beams hereinafter) which are constituted with the main beam (referred to as a CD outward main beam hereinafter), the +first-order sub-beam (referred to as the +first-order CD outward sub-beam hereinafter) and the −first-order sub-beam (referred to as the −first-order CD outward sub-beam hereinafter).

A second polarization beam splitter 75 is disposed at a position on the CD outward-three-beam emission side of the diffraction grating 74, which is also on the optical path between the polarization beam splitter 17 and the collimator lens 18 described in the first embodiment. Thus, the CD outward three beams generated by the diffraction grating 74 make incident on the second polarization beam splitter 75.

The second polarization beam splitter 75 reflects the CD outward three beams making incident form the diffraction grating 74 side towards the collimator lens 18 side.

For the case of using the DVD 15, the outward three beams (referred to as the DVD outward three beams hereinafter) corresponding to the DVD 15 described in the first embodiment make incident on the second polarization beam splitter 75 from the polarization beam splitter 17 side. Further, the inward three beams (referred to as the DVD inward three beams hereinafter) corresponding to the DVD 15 make incident on the second polarization beam splitter 75 from the collimator lens 18 side. The second polarization beam splitter 75 lets through the DVD outward three beams and the DVD inward three beams as they are, regardless of the polarization direction (P-polarization or S-polarization).

The CD outward three beams reflected by the second polarization beam splitter 75 towards the collimator lens 18 side are converted into parallel beams by the collimator lens 18 and emitted towards the raising mirror 20 side.

The CD outward three beams emitted from the collimator lens 18 make incident on the raising mirror 20, which are reflected by the raising mirror 20 towards the quarter-wave plate 21 side.

The CD outward three beams reflected by the raising mirror 20 make incident on the quarter-wave plate 21, which are converted from the linearly polarized light to the circularly polarized light by the quarter-wave plate 21 and emitted towards the objective lens 22 side.

The CD outward three beams emitted from the quarter-wave plate 21 make incident on the objective les 22, which are converted into convergent light by the objective lens 22 to be irradiated towards the CD 71 side.

Thereby, three light spots of the CD outward three beams are irradiated on the recording face of the CD 71.

When irradiated on the recording face of the CD 71 as the light spots, the CD outward three beams are reflected by the recording face of the CD 71 towards the objective lens 22 side as the CD inward three beams.

The CD inward three beams are constituted with the CD inward main beam that is the reflected light of the outward main beam by the recording face of the CD 71, the +first-order CD inward sub-beam that is the reflected light of the +first-order CD outward sub-beam by the recording face of the CD 71, and the −first-order CD inward sub-beam that is the reflected light of the −first-order CD outward sub-beam by the recording face of the CD 71.

Furthermore, when the CD outward three beams are reflected by the recording face of the CD 71, each of the CD outward main beam, the +first-order CD outward sub-beam and the −first-order CD outward sub-beam is branched into a plurality of orders of diffracted light through diffraction and reflected towards the objection lens 22 side.

Thereby, the CD inward main beam of the CD inward three beams travels towards the objective lens 22 side as the light containing the zero-order light and the ±first-order light that are generated by the diffraction when the CD outward main beam is reflected by the recording face of the CD 71.

Further, the +first-order CD inward sub-beam of the CD inward three beams travels towards the objective lens 22 side as the light containing the zero-order light and the ±first-order light that are generated by the diffraction when the +first-order CD outward sub-beam is reflected by the recording face of the CD 71.

Furthermore, the −first-order CD inward sub-beam of the CD inward three beams travels towards the objective lens 22 side as the light containing the zero-order light and the ±first-order light that are generated by the diffraction when the −first-order CD outward sub-beam is reflected by the recording face of the CD 71.

The CD inward three beams reflected by the recording face of the CD 71 are converted into parallel beams by the objective lens 22 to be emitted towards the quarter-wave plate 21 side, which are then converted from the circularly polarized light into linearly polarized light by the quarter-wave plate 21 to be emitted towards the collimator lens 18 side.

The CD inward three beams emitted towards the collimator lens 18 side are converted into convergent light by the collimator lens 18 to be emitted towards the second polarization beam splitter 75 side.

The CD inward three beams emitted towards the second polarization beam splitter 75 transmit through the second polarization beam splitter 75 since the polarization direction thereof is different by 90° with respect to that of the CD outward three beams.

The CD inward three beams transmitting through the second polarization beam splitter 75 make incident on the sensor lens 27 after transmitting the polarization beam splitter 17, which come to have astigmatism through the sensor lens 27. The CD inward three beams are then detected as the three detected light spots by the three light-receiving surfaces of the photodetector 26.

The optical information recording/reproducing apparatus of the embodiment comprising the optical pickup device 72 with such structure is capable of performing at least either recording or reproduction of information not only on the DVD 15 but also on the CD 71.

In the case where the in-line DPP method of the present invention is used for the DVD 15 and the regular (not in-line type) DPP method is used for the CD 71, there may cause the following inconveniences.

As shown in FIG. 22A, when the angle of the photodetector 26 is adjusted in such a manner that the three detected light spots SP_{MAIN}, SP_{+1SUB}, SP_{-1SUB} of the DVD outward three beams are detected at the respective center positions of the three light receiving surfaces of S_{MAIN}, S_{+1SUB}, S_{-1SUB}, the detected light spots SP′_{MAIN}, SP′_{+1SUB}, SP′_{-1SUB} of the CD outward three beams are shifted from the center positions of the three light receiving surfaces of S′_{MAIN}, S′_{+1SUB}, S′_{-1SUB}, as shown in FIG. 22B.

This occurs due to the fact that the diffracting direction when the CD outward three beams are reflected by the recording face of the CD 71 differs from the diffracting direction when the DVD outward three beams are reflected by the recording face of the DVD 15 because the regular DPP method using the diffraction grating 74 is employed for the CD 71.

In order to avoid such inconvenience, it is preferable to employ the in-line DPP method of the present invention also for the CD 71 through using the optical element of the present invention instead of the above-described diffraction grating 74. The optical element 1 used for the CD 71 in place for the diffraction grating 74 may have the first to fifth periodic structures 2, 3, 5, 6, 7 having a different protruded-recessed pitch with respect to that of the optical element 1 used for the DVD 15.

With this, the diffracting direction of the CD outward three beams on the recording face of the CD 71 and that of the DVD outward three beams on the recording face of the DVD 15 can be made consistent with each other. Therefore, the positions of the three detected light spots SP_{MAIN}, SP_{+1SUB}, SP_{-1SUB} on the three light receiving surfaces of S_{MAIN}, S_{+1SUB}, S_{-1SUB} of the photodetector 26 and the positions of the detected light spots SP′_{MAIN}, SP′_{+1SUB}, SP′_{-1SUB} of the CD outward three beams can be made consistent with each other.

With this, it is possible to extend the allowable range for position shift of the detected light spots in the light receiving surfaces of S_{MAIN}, S_{+1SUB}, S_{-1SUB} of the photodetector 26. Thus, at least either recording or reproduction can be more stable performed on both the DVD 15 and the CD 71.

Further, the waveforms of the sub push-pull sum signals corresponding to each light emitted from the DVD light source 14 and the CD light source 73 can be formed in ideal shapes. As a result, fine tracking error signals can be detected in both of the case where the DVD 15 is used and the case where the CD 71 is used.

Furthermore, as described above, in the case where the in-line method of the present invention using the optical element 1 of the present invention is employed for both the DVD 15 and the CD 71, it is more preferable to irradiate the DVD outward three beams on the same track (that is, the land 23) of the recording face of the DVD 15 and irradiate the CD outward three beams on the same track of the recording face of the CD 71.

This can be achieved with a configuration where the periodic direction of the periodic structures 2, 3, 5, 6, 7 of the optical element 1 for the DVD 15 disposed at the light emission side of the DVD light source 14 faces the same direction (radial direction) as that of the periodic structures 2, 3, 5, 6, 7 of the optical element 1 (not shown) for the CD 71, which is disposed at the position of the diffraction grating 74 in place for the diffraction grating 74.

Thereby, the waveforms of the sub push-pull sum signals corresponding to each light emitted from the DVD light source 14 and the CD light source 73 can both be formed in ideal shapes. Therefore, recording and/or reproduction of information can be more properly performed on both the DVD 15 and the CD 71.

Positions of the DVD light source 14 and the CD light source 73 in FIG. 21 may be switched. In that case, however, it is necessary to switch the positions of the optical element 1 and the diffraction grating 74, and the positions of the polarization beam splitter 17 and the second polarization beam splitter 75.

Furthermore, although the embodiment uses the DVD light source 14 and the CD light source 73 as the two light sources for respectively emitting the coherent light having different wavelength from each other, it is not intended to be limited to those. Instead, the DVD light source 14 and a Blu-ray light source may be used or the DVD light source 14 and an HD-DVD light source may be used. Alternatively, the CD light source 73 and an HD-DVD light source may be used or the CD light source 73 and a Blu-ray light source may be used.

Moreover, the same effect can be achieved even when the optical element 51 of the second embodiment or the optical element 60 of the third embodiment is used as the optical element.

### Third Embodiment of Optical Pickup Device and Optical Information Recording/Reproducing Apparatus

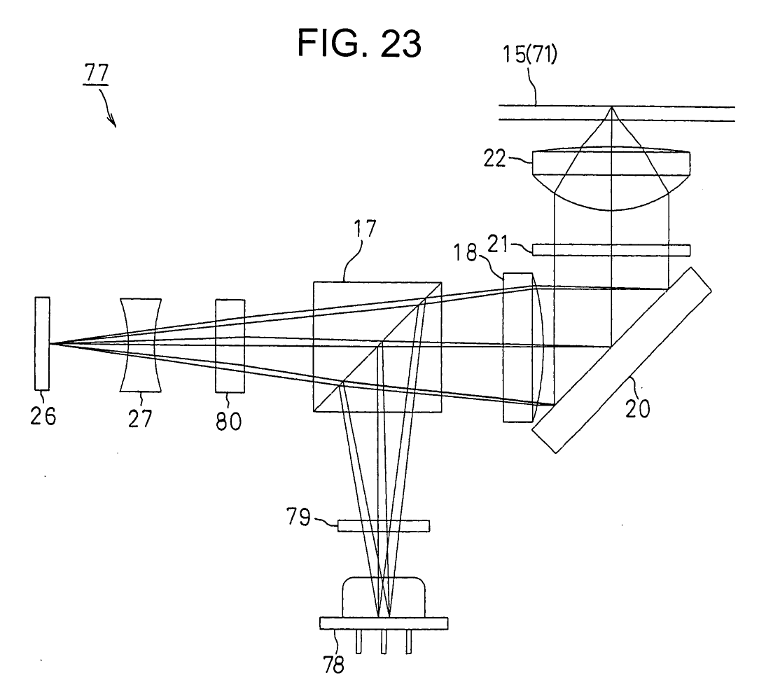

Next, a third embodiment of the optical pickup device and the optical information recording/reproducing apparatus will be described by referring to FIG. 23, emphasizing on the difference with respect to the first embodiment and the second embodiment.

The same reference numerals are used to describe the parts whose fundamental structures are identical or similar to those of the first and second embodiments.

Like the above-described optical information recording/reproducing apparatus of the second embodiment, the optical information recording/reproducing apparatus according to the third embodiment is capable of performing at least either recording or reproduction of information on both the DVD 15 and the CD 71.

However, in this embodiment, an optical pickup device 77 of the optical information recording/reproducing apparatus is different from that of the second embodiment. The optical pickup device 77 comprises, as the light source, a two-wavelength light source 78 that selectively emits coherent light (first light) with the wavelength of 660 nm for corresponding to the DVD 15 and coherent light (second light) with the wavelength of 780 nm for corresponding to the CD 71.

Further, unlike the above-described optical element 1, an optical element 79 is disposed at the position on the light emission side of the two-wavelength light source 78. The optical element 79 has a diffraction grating 1a (not shown), which comprises the first to fifth periodic structures 2, 3, 5, 6, 7 corresponding to the first light (λ=660 nm) for the DVD 15 in the surface on the two-wavelength light source 78 side in the thickness direction (longitudinal direction in FIG. 23), formed at the position on the light emission side of the two-wavelength light source 78, and has a grating surface with the typical diffraction grating corresponding to the second light (λ=780 nm) for the CD 71 formed on the opposite side of the two-wavelength light source 78 in the thickness direction.

When the first light is emitted from the two-wavelength light source 78, the optical element 79 generates the DVD outward three beams through diffracting the first light by the grating surface 1a on the two-wavelength light source 78 side. In that state, the grating surface on the opposite side of the two-wavelength light source 78 lets through the DVD outward three beams without diffraction.

The DVD outward three beams generated by the optical element 79 make incident on the polarization beam splitter 17.

When the second light is emitted from the two-wavelength light source 78, the optical element 79 generates the CD outward three beams through diffracting the second light by the grating surface on the opposite side of the two-wavelength light source 78. In that state, the grating surface 1a on the two-wavelength light source 78 side lets through the second light without diffraction.

The CD outward three beams generated by the optical element 79 make incident on the polarization beam splitter 17.

Like the first and second embodiments, the DVD outward three beams are irradiated onto the recording face of the DVD 15 through the polarization beam splitter 17, the collimator lens 18, the raising mirror 20, the quarter-wave plate 21, and the objective lens 22. After reflected by the recording face of the DVD 15, the DVD outward three beams travel backwards on the outward path as the DVD inward three beams to return to the polarization beam splitter 17, which then travel towards the photodetector 26 side after transmitting through the polarization beam splitter 17.

Likewise, the CD outward three beams are also irradiated onto the recording face of the CD 71 through the polarization beam splitter 17, the collimator lens 18, the raising mirror 20, the quarter-wave plate 21, and the objective lens 22. After reflected by the recording face of the CD 71, the CD outward three beams travel backwards on the outward path as the CD inward three beams to return to the polarization beam splitter 17, which then travel towards the photodetector 26 side after transmitting through the polarization beam splitter 17.

Further, unlike the optical pickup device 10 of the first embodiment, the optical pickup device 77 of this embodiment comprises an optical-axis correcting element 80 provided on the optical path between the sensor lens 27 disposed in front of the photodetector 26 and the polarization beam splitter 17.

The optical-axis correcting element 80 deflects the CD inward three beams and lets the DVD inward three beams travel straightforward so that the DVD inward three beams and the CD inward three beams transmitting through the polarization beams splitter 17 properly make incident on the light receiving surfaces of the photodetector 26.

The optical-axis correcting element 80 may deflect the DVD inward three beams and let the CD inward three beams travel straightforward.

Like the optical information recording/reproducing apparatus of the second embodiment, the optical information recording/reproducing apparatus of this embodiment comprising the optical pickup device 77 with such configuration is capable of performing at least either recording or reproduction of information on both the DVD 15 and the CD 71.

Furthermore, the embodiment enables reduction in the number of components compared to the case of the second embodiment, thereby achieving size-reduction of the apparatus.

As a more preferable embodiment, the diffraction grating 1a comprising the first to fifth periodic structures 2, 3, 5, 6, 7 according to the present invention may be formed on the surface of the optical element 79 on the opposite side of the two-wavelength light source 78 as the grating surface for corresponding to the second light for the CD 71, instead of forming the typical grating surface described above.

In that case, the diffraction grating 1a for the CD 71 formed on the surface on the opposite side of the two-wavelength light source 78 may have the first to fifth periodic structures 2, 3, 5, 6, 7 having the different protruded-recessed pitch with respect to that of the diffraction grating 1a for the DVD 15 formed on the two-wavelength light source 78 side for corresponding to the wavelength (780 nm) of the second light.

Like the second embodiment, this allows the diffracting direction of the CD outward three beams on the recording face of the CD 71 and that of the DVD outward three beams on the recording face of the DVD 15 to be made consistent with each other. Therefore, it is possible to extend the allowable range for position shift of the detected light spots in the light receiving surfaces of the photodetector 26.

Further, the waveforms of the sub push-pull sum signals corresponding to each light emitted from the two-wavelength light source 78 can be formed in ideal shapes also in the case of using the two-wavelength light source 78. As a result, fine tracking error signals can be detected in both of the case where the DVD 15 is used and the case where the CD 71 is used.

Furthermore, like the second embodiment, it is preferable to irradiate the DVD outward three beams on the same track (that is, the land 23) of the recording face of the DVD 15 (first optical information recording medium) and irradiate the CD outward three beams on the same track of the recording face of the CD 71 (second optical information recording medium).

This can be achieved with a configuration where the periodic direction of the periodic structures 2, 3, 5, 6, 7 of the grating surface 1a for the DVD 15 formed on the two-wavelength light source 78 face the same direction (radial direction) as that of the periodic structures 2, 3, 5, 6, 7 of the grating surface 1a for the CD 71, which is formed on the surface on the opposite side of the two-wavelength light source 78.

Thereby, the waveforms of the sub push-pull sum signals corresponding to the first light for the DVD 15 and the second light for the CD 71 can both be formed in ideal shapes. Therefore, recording and/or reproduction of information can be more properly performed on both the DVD 15 and the CD 71.

Although the embodiment uses the light (λ=660 nm) for the DVD 15 and the light (λ=780 nm) for the CD 71 as the first light and the second light which are selectively emitted from the two-wavelength light source 78, it is not intended to be limited to those. Instead, the light for DVD 15 and Blu-ray light (λ=405 nm) may be used or the light for the DVD 15 and HD-DVD light (λ=405 nm) may be used. Alternatively, the light for the CD 71 and HD-DVD light may be used or the light for the CD 71 and Blu-ray light may be used.

Moreover, the same effect can be achieved even when the periodic structures 52-58 of the optical element 51 according to the second embodiment or the periodic structures 61-69 of the optical element 60 according to the third embodiment are used as the periodic structures of the optical element 79.

### Fourth Embodiment of Optical Pickup Device and Optical Information Recording/Reproducing Apparatus

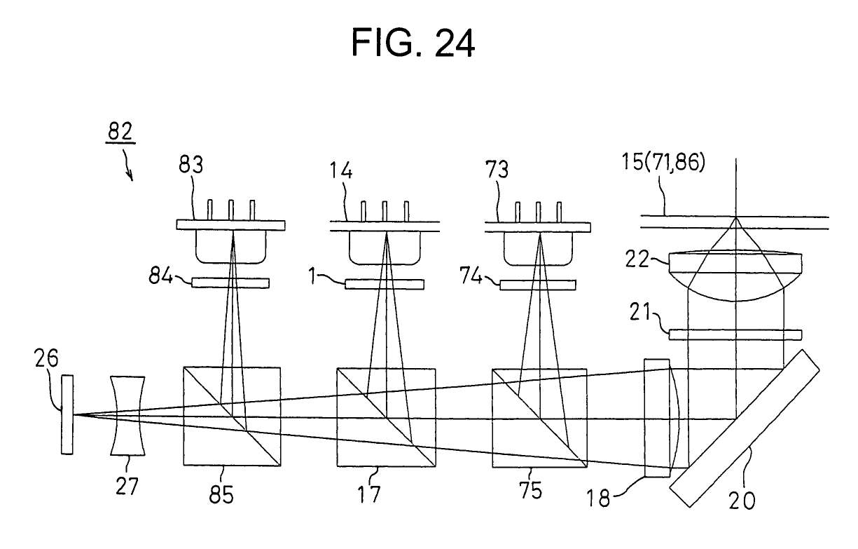

Next, a fourth embodiment of the optical pickup device and the optical information recording/reproducing apparatus will be described by referring to FIG. 24, emphasizing on the difference with respect to the first-third embodiments.

The same reference numerals are used to describe the parts whose fundamental structures are identical or similar to those of the first-third embodiments.

In addition to the structure of the above-described optical information recording/reproducing apparatus of the second embodiment, the optical information recording/reproducing apparatus according to the fourth embodiment is capable of performing at least either recording or reproduction of information also on a Blu-ray disk as an optical information recording medium.

That is, as shown in FIG. 24, an optical pickup device 82 of the optical information recording/reproducing apparatus according to the fourth embodiment comprises a Blu-ray light source 83 in addition to the structures of the optical pickup device 72 of the second embodiment. The Blue-ray light source 83 emits coherent light with the wavelength of 405 nm for corresponding to the Blu-ray disk.

As the diffraction structure, there is a typical (well-known) diffraction grating 84 with a single periodic structure (not shown), which corresponds not to the in-line DPP method of the present invention but to the regular DPP method, disposed at a position on the light emission side of the Blue-ray light source 83. Light emitted from the Blu-ray light source 83 makes incident on the diffraction grating 84.

The diffraction grating 84 diffracts the light making incident from the Blu-ray light source 83 to generate the three beams (referred to as Blu-ray outward three beams hereinafter) which are constituted with the main beam (referred to as a Blu-ray outward main beam hereinafter), the +first-order sub-beam (referred to as the +first-order Blu-ray outward sub-beam hereinafter) and the −first-order sub-beam (referred to as the −first-order Blu-ray outward sub-beam hereinafter).

A third polarization beam splitter 85 is disposed at a position on the Blu-ray outward-three-beam emission side of the diffraction grating 84, which is also on the optical path between the sensor lens 27 and the polarization beam splitter 17. Thus, the Blu-ray outward three beams generated by the diffraction grating 84 make incident on the third polarization beam splitter 85.

The third polarization beam splitter 85 reflects the Blu-ray outward three beams making incident form the diffraction grating 84 side towards the polarization beam splitter 17 side.

When the DVD 15 or the CD 71 is used, the DVD outward three beams or the CD outward three beams make incident on the third polarization beam splitter 85 from the polarization beam splitter 17 side. The third polarization beam splitter 85 lets through the DVD inward three beams and the CD inward three beams towards the sensor lens 27 side as they are, regardless of the directions of the polarization (P-polarization or S-polarization).

The Blu-ray outward three beams reflected by the third polarization beam splitter 85 towards the polarization beam splitter 17 side make incident on the second polarization beam splitter 75 after transmitting through the polarization beam splitter 75.

The Blu-ray outward three beams making incident on the second polarization beam splitter 75 transmits through the second polarization beam splitter 75 and make incident on the collimator lens 18.

The Blu-ray outward three beams making incident on the collimator lens 18 are converted into parallel beams by the collimator lens 18 and emitted towards the raising mirror 20 side.

The Blu-ray outward three beams emitted from the collimator lens 18 make incident on the raising mirror 20, which are reflected by the raising mirror 20 towards the quarter-wave plate 21 side.

The Blu-ray outward three beams reflected by the raising mirror 20 make incident on the quarter-wave plate 21, which are converted from the linearly polarized light into the circularly polarized light by the quarter-wave plate 21 and emitted towards the objective lens 22 side.

The Blu-ray outward three beams emitted from the quarter-wave plate 21 make incident on the objective les 22, which are converted into convergent light by the objective lens 22 to be irradiated towards the Blu-ray disk 86 side.

Thereby, three light spots of the Blu-ray outward three beams are irradiated on the recording face of the Blu-ray disk 86.

When irradiated on the recording face of the Blu-ray disk 86 as the light spots, the Blu-ray outward three beams are reflected by the recording face of the Blu-ray disk towards the objective lens 22 side as the Blu-ray inward three beams.

The Blu-ray inward three beams are constituted with the Blu-ray inward main beam that is the reflected light of the outward main beam by the recording face of the Blu-ray disk 86, the +first-order Blu-ray inward sub-beam that is the reflected light of the +first-order Blu-ray outward sub-beam by the recording face of the Blu-ray disk 86, and the −first-order Blu-ray inward sub-beam that is the reflected light of the −first-order Blu-ray outward sub-beam by the recording face of the Blu-ray disk 86.

Furthermore, when the Blu-ray outward three beams are reflected by the recording face of the Blu-ray disk 86, each of the Blu-ray outward main beam, the +first-order Blu-ray outward sub-beam and the −first-order Blu-ray outward sub-beam is branched into a plurality of orders of diffracted light through diffraction and reflected towards the objection lens 22 side.

Thereby, the Blu-ray inward main beam of the Blu-ray inward three beams travels towards the objective lens 22 side as the light containing the zero-order light and the +first-order light that are generated by diffraction when the Blu-ray outward main beam is reflected by the recording face of the Blu-ray disk 86.

Further, the +first-order Blu-ray inward sub-beam of the Blu-ray inward three beams travels towards the objective lens 22 side as the light containing the zero-order light and the +first-order light that are generated by the diffraction when the +first-order Blu-ray outward sub-beam is reflected by the recording face of the Blu-ray disk 86.

Furthermore, the −first-order Blu-ray inward sub-beam of the Blu-ray inward three beams travels towards the objective lens 22 side as the light containing the zero-order light and the +first-order light that are generated by the diffraction when the −first-order Blu-ray outward sub-beam is reflected by the recording face of the Blu-ray disk 86.

The Blu-ray inward three beams reflected by the recording face of the Blu-ray disk 86 are converted into parallel beams by the objective lens 22 to be emitted towards the quarter-wave plate 21 side, which are then converted from the circularly polarized light into linearly polarized light by the quarter-wave plate 21 to be emitted towards the collimator lens 18 side.

The Blu-ray inward three beams emitted towards the collimator lens 18 side are converted into convergent light by the collimator lens 18 to be emitted towards the second polarization beam splitter 75 side.

The Blu-ray inward three beams emitted towards the second polarization beam splitter 75 side transmit through the second polarization beam splitter 75 and make incident on the polarization beam splitter 17.

The Blu-ray inward three beams making incident on the polarization beam splitter 17 transmit through the polarization beam splitter 17 and make incident on the third polarization beam splitter 85.

In that state, the Blu-ray inward three beams transmit through the third polarization beam splitter 85 and make incident on the sensor lens 27 since the polarization direction thereof is different by 90° with respect to that of the Blu-ray outward three beams.

The Blu-ray inward three beams making incident on the sensor lens 27 come to have astigmatism through the sensor lens 27, which are then detected as the three detected light spots by the three light-receiving surfaces of the photodetector 26.

The optical information recording/reproducing apparatus of the embodiment comprising the optical pickup device 82 with such configuration is capable of performing at least either recording or reproduction of information not only on the DVD 15 and the CD 71 but also on the Blu-ray disk 86.

As a more preferable embodiment, the optical element 1 of the present invention may be used instead of the above-described diffraction grating 84, and the in-line DPP method of the present invention may be employed for the Blu-ray disk 86 as well. Likewise, the in-line DPP method using the optical element 1 according to the present invention may be employed for the CD 71.

In that case, the optical element 1 used for the Blu-ray instead of the diffraction grating 84 may have the first to fifth periodic structures 2, 3, 5, 6, 7 having the different protruded-recessed pitch with respect to that of the optical element 1 for the DVD 15 and the optical element 1 for the CD 71 used instead of the diffraction grating 74.

With this, the diffracting direction of the Blu-ray outward three beams on the recording face of the Blu-ray disk 86, the diffracting direction of the DVD outward three beams on the recording face of the DVD 15, and the diffracting direction of the CD outward three beams on the recording face of the CD 71 can be made consistent with each other. Thereby, the positions of the detected light spots of the DVD inward three beams, the positions of the detected light spots of the Blu-ray inward three beams, and the positions of the detected light spots of the CD inward three beams on the light receiving surfaces of the photodetector 26 can be made consistent with each other.

Therefore, it is possible to extend the allowable range for position shift of the detected light spots in the light receiving surfaces of the photodetector 26. As a result, at least either recording or reproduction can be more stably performed on the DVD 15, the Blu-ray disk 86 and the CD 71.

Further, the waveforms of the sub push-pull sum signals corresponding to each light emitted from the DVD light source 14, the Blu-ray light source 83, and the CD light source 73 can be formed in ideal shapes. As a result, fine tracking error signals can be detected in all of the cases where the DVD 15 is used, the Blu-ray disk 86 is used, or the CD 71 is used.

Furthermore, it is more preferable to irradiate the DVD outward three beams on the same track (that is, the land 23) of the recording face of the DVD 15, irradiate the Blu-ray outward three beams on the same track of the recoding face of the Blu-ray disk 86, and irradiate the CD outward three beams on the same track of the recording face of the CD 71.

This can be achieved with a configuration where the periodic direction of the periodic structures 2, 3, 5, 6, 7 of the optical element 1 for the DVD 15 disposed on the light emission side of the DVD light source 14, the periodic direction of the of the periodic structures 2, 3, 5, 6, 7 of the optical element 1 for the Blu-ray disposed instead of the diffraction grating 84 at the position of the diffraction grating 84 for the Blu-ray, and the periodic direction of the of the periodic structures 2, 3, 5, 6, 7 of the optical element 1 for the CD 71 disposed instead of the diffraction grating 74 at the position of the diffraction grating 74 for the CD 71 face the same direction (radial direction).

Thereby, the waveforms of the sub push-pull sum signals corresponding to the light emitted from the DVD light source 14, the Blu-ray light source 83, and the CD light source 73 can all be formed in ideal shapes. Therefore, recording and/or reproduction of information can be more properly performed on all of the DVD 15, Blu-ray disk 86 and the CD 71.

The positions of the light sources can be switched also in this embodiment. In that case, it is necessary to switch the positions of the optical elements (diffraction gratings) and the polarization beam splitters, which correspond to the respective light sources, disposed at the positions on the light emission side of the respective light sources.

Although the embodiment uses the DVD light source 14, the Blu-ray light source 83, and the CD light source 73 as the three light sources for emitting the coherent light having different wavelength from each other, it is not intended to be limited to those. The DVD light source 14, an HD-DVD light source, and the CD light source 73 may be used as well.

Moreover, the same effect can be achieved even when the optical element 51 according to the second embodiment or the optical element 60 according to the third embodiment is used instead of the optical element 1.

### Fifth Embodiment of Optical Pickup Device and Optical Information Recording/Reproducing Apparatus

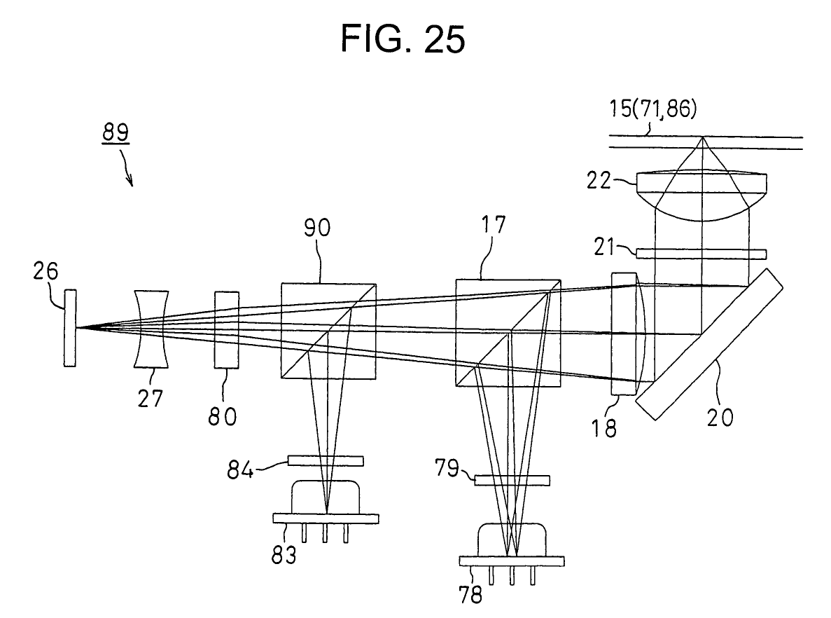

Next, a fifth embodiment of the optical pickup device and the optical information recording/reproducing apparatus will be described by referring to FIG. 25, emphasizing on the difference with respect to the first-fourth embodiments.

The same reference numerals are used to describe the parts whose fundamental structures are identical or similar to those of the first-fourth embodiments.

In addition to the structure of the above-described optical information recording/reproducing apparatus of the third embodiment, the optical information recording/reproducing apparatus according to the fifth embodiment is capable of performing at least either recording or reproduction of information also on the Blu-ray disk 86.

That is, as shown in FIG. 25, an optical pickup device 89 of the optical information recording/reproducing apparatus according to the fifth embodiment comprises, in addition to the structure of the optical pickup device 77 of the third embodiment, a second polarization beam splitter 90 in the same structure as that of the third polarization beam splitter 85 of the fourth embodiment, which is disposed on the optical path between the optical-axis correcting element 80 and the polarization beam splitter 17.

Further, the diffraction grating 84 and the Blu-ray light source 83 described in the fourth embodiment are disposed at the oppositions on the light emission side of the second polarization beam splitter 90.

The actions of the Blu-ray light source 83, the diffraction grating 84, and the second polarization beam splitter 90 are the same as those in the fourth embodiment so that the description thereof will be omitted.

The optical information recording/reproducing apparatus of the embodiment comprising the optical pickup device 89 with such configuration is capable of performing at least either recording or reproduction of information on the DVD 15, the Blu-ray disk 86 and the CD 71.

Furthermore, it is possible to reduce the number of components compared to the case of using the optical pickup device 82 of the fourth embodiment, thereby achieving size-reduction of the apparatus.

Because of the same reasons described in the fourth embodiment, it is also preferable in the fifth embodiment to use the optical element 1 of the present invention instead of the diffraction grating for the Blu-ray, and also uses the grating surface 1a comprising the periodic structures 2, 3, 5, 6, 7 according to the present invention as the grating surface of the optical element 79 for generating the CD outward three beams.

Furthermore, it is more preferable to irradiate the DVD outward three beams on the same track (that is, the land 23) of the recording face of the DVD 15, irradiate the Blu-ray outward three beams on the same track of the recoding face of the Blu-ray disk 86, and irradiate the CD outward three beams on the same track of the recording face of the CD 71.

Further, like the fourth embodiment, an HD-DVD light source may be used instead of the Blu-ray light source 83.

It is needles to say that the periodic structures 52-58 of the optical element 51 according to the second embodiment or the periodic structures 61-69 of the optical element 60 according to the third embodiment may be used as the periodic structures of the optical element 79.

### Sixth Embodiment of Optical Pickup Device and Optical Information Recording/Reproducing Apparatus

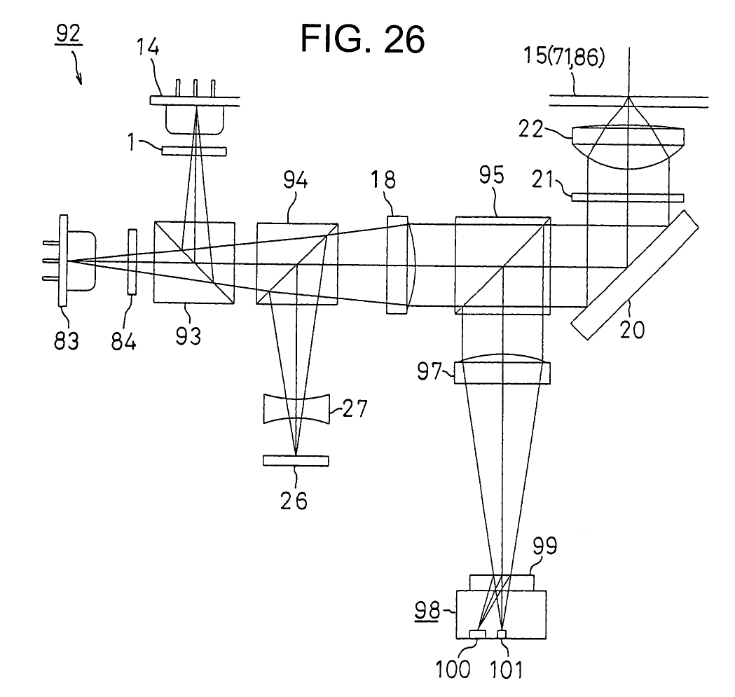

Next, a sixth embodiment of the optical pickup device and the optical information recording/reproducing apparatus will be described by referring to FIG. 26, emphasizing on the difference with respect to the first-fifth embodiments.

The same reference numerals are used to describe the parts whose fundamental structures are identical or similar to those of the first-fifth embodiments.

Like the optical information recording/reproducing apparatus according to the fourth and fifth embodiments, the optical information recording/reproducing apparatus according to the sixth embodiment is capable of performing at least either recording or reproduction of information on the DVD 15, the Blu-ray disk 86, and the CD 71.

That is, an optical pickup device 92 of the optical information recording/reproducing apparatus according to this embodiment comprises, in stead of the polarization beam splitter 17 of the first embodiment, a first dichroic prism 93 as an optical system for reflecting the DVD outward three beams that are generated by the optical element 1 disposed at a position on the light emission side of the DVD light source 14.

The diffraction grating 84 and the Blu-ray light source 83 described in the fourth embodiment are disposed at the positions on the incident side of the first dichroic prism 93, on which the light orthogonal to the DVD outward three beams makes incident. The first dichroic prism 93 lets through the Blu-ray outward three beams generated by diffraction of the diffraction grating 84, allowing them to travel in the same direction as that of the DVD outward three beams.

A polarization beam splitter 94 is disposed on the optical path between the first dichroic prism 93 and the collimator lens 18.

The polarization beam splitter 94 lets through the DVD outward three beams and the Blu-ray outward three beams emitted from the first dichroic prism 93 as they are and allows them to travel toward the collimator lens 18 side.

Further, the polarization beam splitter 94 reflects the DVD inward three beams and the Blu-ray inward three beams making incident from the collimator lens 18 side.

The above-described sensor lens 27 and the photodetector 26 are disposed at the positions on the reflection side of the DVD inward three beams and the Blu-ray inward three beams with respect to the polarization beam splitter 94.

In other words, the photodetector 26 detects only the DVD inward three beams and the Blu-ray inward three beams in this embodiment.

A second dichroic prism 95 is disposed on the optical path between the collimator lens 18 and the raising mirror 20. The second dichroic prism 95 lets through the DVD outward three beams and the Blu-ray outward three beams making incident from the collimator lens 18 side towards the raising mirror 20 side.

Further, the second dichroic prism 95 lets through the DVD inward three beams and the Blu-ray inward three beams making incident from the raising mirror 20 side towards the collimator lens 18 side.

A coupling lens 97 and a photodetector-cum-light source 98 for CD are disposed at the positions on the incident side of the second dichroic prism 95, on which the light orthogonal to the DVD outward three beams and the Blu-ray outward three beams makes incident.

Like the CD light source 73, the photodetector-cum light source 98 emits, from an LD 101 for CD, the coherent light with the wavelength of 780 nm for corresponding to the CD 71.

The photodetector-cum-light source 98 comprises an optical element 99 having both a hologram surface and a typical diffraction grating 74 provided at the light emission side of the LD 101 for CD.

By the grating surface, the optical element 99 diffracts the light emitted from the LD 101 for CD for generating the CD outward three beams.

The CD outward three beams generated by the optical element 99 are converted into parallel beams by the coupling lens 97 to be emitted towards the second dichroic prism 95 side.

The CD outward three beams emitted from the second dichroic prism 95 are reflected by the second dichroic prism 95 towards the raising mirror 20 side.

Further, the CD inward three beams make incident on the second dichroic prism 95 from the raising mirror 20 side.

The second dichroic prism 95 reflects the CD inward three beams towards the coupling lens 97 side.

The coupling lens 97 converts the CD inward thee beams reflected by the second dichroic prism 95 into convergent light to be emitted towards the optical element 99 side.

By the hologram surface, the optical element 99 diffracts the CD inward three beams emitted from the coupling lens 97 towards a light-receiving element 100 that is arranged at a position different from that of the LD 101 for CD. Thereby, the detected light spots of the CD inward three beams are detected on the light receiving surface of the light-receiving element 100.

Like the fourth and fifth embodiments, the optical information recording/reproducing apparatus of this embodiment comprising the optical pickup device 92 with such configuration is capable of performing at least either recording or reproduction of information on the DVD 15, the Blu-ray disk 86, and the CD 71.

Furthermore, since the coupling lens 97 and the photodetetcor-cum-light source 98 are provided exclusively for the CD 71, it is possible to improve the possible design from of the optical system and the sensor 26 for corresponding to the DVD 15 and the Blu-ray disk 86, without considering the compatibility with the CD 71. As a result, recording property and reproducing property for the DVD 15, the Blu-ray disk 86, and the CD 71 can be improved.

Because of the same reasons described in the fourth embodiment, it is also preferable in the sixth embodiment to use the diffraction grating 1a comprising the periodic structures 2, 3, 5, 6, 7 of the optical element 1 according to the present invention as the grating surface of the optical element 99, and also use the optical element 1 of the present invention instead of the diffraction grating 84 for the Blu-ray.

Furthermore, because of the same reasons described in the fourth embodiment, it is more preferable to irradiate the DVD outward three beams on the same track (that is, the land 23) of the recording face of the DVD 15, irradiate the Blu-ray outward three beams on the same track of the recoding face of the Blu-ray disk 86, and irradiate the CD outward three beams on the same track of the recording face of the CD 71.

Further, like the fourth embodiment, an HD-DVD light source may be used instead of the Blu-ray light source 83.

Needless to say, the optical element 51 according to the second embodiment or the optical element 60 according to the third embodiment may be used instead of the optical element 1.

The present invention is not limited to the above-described embodiments but various modifications are possible as necessary.

For example, the number of the periodic structures is not necessarily limited to be nine as described above.

By way of example, five or more periodic structures being adjacent to each other may be formed at positions adjacent in one of the directions orthogonal to the periodic direction of the first periodic structure, along the periodic direction of the first periodic structure, and five or more periodic structures being adjacent to each other may be formed at positions adjacent in the other direction orthogonal to the periodic direction of the first periodic structure, along the periodic direction of the first periodic structure.

In such a case, it is also possible to achieve the same effects as those of the above-described embodiments by forming the configuration in such a manner that: all the periodic structures except the first periodic structure have the phase difference of 90° with respect to the first periodic structure; the phases of the periodic structures being adjacent to each other in the periodic direction of the first periodic structure differ by 180° from each other; and the phases of the opposing periodic structures with the first periodic structure being interposed between differ by 180° from each other.

What is claimed is:

1. An optical element for generating at least three beams by diffracting coherent light, comprising, on at least one of surfaces in a thickness direction, a grating surface that includes at least:
a first periodic structure;
a second periodic structure formed at a position adjacent to said first periodic structure in one of directions orthogonal to a periodic direction of said first periodic structure in such a manner that there is a phase difference of 90° with respect to said first periodic structure;
a third periodic structure formed at a position which is adjacent to said first periodic structure in said one of directions orthogonal to said periodic direction of said first periodic structure and also adjacent to said second periodic structure in said periodic direction of said first periodic structure, in such a manner that there is a phase difference of 90° with respect to said first periodic structure and a phase difference of 180° with respect to said second periodic structure;
a fourth periodic structure formed at a position which is adjacent to said first periodic structure in other direction orthogonal to said periodic direction of said first periodic structure and also opposed to said second periodic structure with said first periodic structure being interposed therebetween, in such a manner that there is a phase difference of 90° with respect to said first periodic structure and a phase difference of 180° with respect to said second periodic structure; and
a fifth periodic structure formed at a position adjacent to said first periodic structure in said other direction orthogonal to said periodic direction of said first periodic structure, which is opposed to said third periodic structure with said first periodic structure being interposed therebetween and also adjacent to said fourth periodic structure in said periodic direction of said first periodic structure, in such a manner that there is a phase difference of 90° with respect to said first periodic structure, a phase difference of 180° with respect to said third periodic structure, and a phase difference of 180° with respect to said fourth periodic structure.

2. An optical element for generating at least three beams by diffracting coherent light, comprising, on at least one of surfaces in a thickness direction, a grating surface that includes at least:
a first periodic structure;
a plurality of periodic structures from second to n-th (n: a natural number of 3 or larger, same applies hereinafter) formed in order along a periodic direction of said first periodic structure to be adjacent to each other in a periodic direction of said first periodic structure at positions adjacent to said first periodic structure in one of directions orthogonal to said periodic direction of said first periodic structure, wherein all of said second to n-th periodic structures have a phase difference of 90° with respect to said first periodic structure, and phases of said periodic structures that are adjacent in said periodic direction of said first periodic structure are different from each other by 180°; and
a plurality of periodic structures from (n+1)-th to (2n−1)-th formed in order along said periodic direction of said first periodic structure to be adjacent to each other in said periodic direction of said first periodic structure at positions adjacent to said first periodic structure in other one of directions orthogonal to said periodic direction of said first periodic structure, wherein: all of said (n+1)-th to (2n−1)-th periodic structures have a phase difference of 90° with respect to said first periodic structure, and phases of said periodic structures that are adjacent in said periodic direction of said first periodic structure are different from each other by 180°; (n+k)-th periodic structure (k: a natural number between 1 and n−1, inclusive, same applies hereinafter) of said (n+1)-th to (2n−1)-th periodic structures opposes (k+1)-th periodic structure of said (n+1)-th to (2n−1)-th periodic structures with said first periodic structure being interposed therebetween; and said (n+k)-th periodic structure has a phase difference of 180° with respect to said (k+1)-th periodic structure.

3. The optical element according to claim 1 or 2, comprising said grating surface formed on one of surfaces in thickness direction for corresponding to first coherent light, and said grating surface formed on other surface in said thickness direction for corresponding to second coherent light whose wavelength is different from that of said first light.

4. An optical pickup device, comprising at least:
a light source for emitting coherent light;
a diffraction structure for generating three beams by diffracting light emitted from said light source;
an objective lens that condenses said three beams generated by said diffraction structure for irradiating light spots of said three beams onto a recording face of an optical information recording medium; and
a photodetector that receives and detects reflected light of said light spots of said three beams which are reflected by said optical information recording medium, wherein
said diffraction structure comprises, on at least one of surfaces in thickness direction, a grating surface including at least:
a first periodic structure;
a second periodic structure formed at a position adjacent to said first periodic structure in one of directions orthogonal to a periodic direction of said first periodic structure in such a manner that there is a phase difference of 90° with respect to said first periodic structure;
a third periodic structure formed at a position which is adjacent to said first periodic structure in said one of directions orthogonal to said periodic direction of said first periodic structure and also adjacent to said second periodic structure in said periodic direction of said first periodic structure, in such a manner that there is a phase difference of 90° with respect to said first periodic structure and a phase difference of 180° with respect to said second periodic structure;
a fourth periodic structure formed at a position which is adjacent to said first periodic structure in other direction orthogonal to said periodic direction of said first periodic structure and also opposed to said second periodic structure with said first periodic structure being interposed therebetween, in such a manner that there is a phase difference of 90° with respect to said first periodic structure and a phase difference of 180° with respect to said second periodic structure; and
a fifth periodic structure formed at a position adjacent to said first periodic structure in said other direction orthogonal to said periodic direction of said first periodic structure, which is opposed to said third periodic structure with said first periodic structure being interposed therebetween and also adjacent to said fourth periodic structure in said periodic direction of said first periodic structure, in such a manner that there is a phase difference of 90° with respect to said first periodic structure, a phase difference of 180° with respect to said third periodic structure, and a phase difference of 180° with respect to said fourth periodic structure.

5. An optical pickup device, comprising at least:
a light source for emitting coherent light;
a diffraction structure for generating three beams by diffracting light emitted from said light source;
an objective lens that condenses said three beams generated by said diffraction structure for irradiating light spots of said three beams onto a recording face of an optical information recording medium; and
a photodetector that receives and detects reflected light of said light spots of said three beams which are reflected by said optical information recording medium, wherein
said diffraction structure comprises, on at least one of surfaces in thickness direction, a grating surface including at least:
a first periodic structure;
a plurality of periodic structures from second to n-th (n: a natural number of 3 or larger, same applies hereinafter) formed in order along a periodic direction of said first periodic structure to be adjacent to each other in said periodic direction of said first periodic structure at positions adjacent to said first periodic structure in one of directions orthogonal to said periodic direction of said first periodic structure, wherein all of said second to n-th periodic structures have a phase difference of 90° with respect to said first periodic structure, and phases of said periodic structures that are adjacent in said periodic direction of said first periodic structure are different from each other by 180°; and
a plurality of periodic structures from (n+1)-th to (2n−1)-th formed in order along said periodic direction of said first periodic structure to be adjacent to each other in said periodic direction of said first periodic structure at positions adjacent to said first periodic structure in other one of directions orthogonal to said periodic direction of said first periodic structure, wherein: all of said (n+1)-th to (2n−1)-th periodic structures have a phase difference of 90° with respect to said first periodic structure, and phases of said periodic structures that are adjacent in said periodic direction of said first periodic structure are different from each other by 180°; (n+k)-th periodic structure (k: a natural number between 1 and n−1, inclusive, same applies hereinafter) of said (n+1)-th to (2n−1)-th periodic structures opposes (k+1)-th periodic structure of said (n+1)-th to (2n−1)-th periodic structures with said first periodic structure being interposed therebetween; and said (n+k)-th periodic structure has a phase difference of 180° with respect to said (k+1)-th periodic structure.

6. The optical pickup device according to claim 4 or 5, comprising:
as said light source, a plurality of light sources each emitting coherent light having a different wavelength from each other; and
as said diffraction structure, a plurality of diffraction structures each having said grating surface for corresponding to said coherent light emitted from said plurality of light sources.

7. The optical pickup device according to claim 6, wherein light spots of three beams that are generated by an arbitrary diffraction structure among said plurality of diffraction structures are irradiated onto a same track on a recording face of an optical information recording medium that corresponds to said three beams.

8. The optical pickup device according to claim 4 or 5, wherein:
said light source is formed to selectively emit coherent first light or coherent second light having a wavelength different from that of said first light; and
said diffraction structure comprises said grating surface on one of surfaces in said thickness direction for corresponding to said first light, and comprises said grating surface on other surface in said thickness direction for corresponding to said second light.

9. The optical pickup device according to claim 8, wherein
light spots of three beams that are generated by said grating surface corresponding to said first light are irradiated onto a same track on a recording face of a first optical information recording medium that corresponds to said three beams, and
light spots of three beams that are generated by said grating surface corresponding to said second light are irradiated onto a same track on a recording face of a second optical information recording medium that corresponds to said three beams.

10. An optical information recording and/or reproducing apparatus for performing at least either recording of information to an optical information recording medium or reproduction of information recorded to said optical information recording medium while controlling position of an objective lens by an objective lens position control device, said optical recording and/or reproducing apparatus comprising, at least:
a light source for emitting coherent light;
a diffraction structure for generating three beams by diffracting light emitted from said light source;
an objective lens that condenses said three beams generated by said diffraction structure for irradiating light spots of said three beams onto a recording face of said optical information recording medium;
a photodetector that receives and detects reflected light of said light spots of said three beams which are reflected by said optical information recording medium;
a tracking error signal detecting device for detecting a tracking error signal based on a detected result of said photodetector; and
said objective lens position control device for controlling position of said objective lens based on a detected result of said tracking error signal detecting device, wherein
said diffraction structure comprises, on at least one of surfaces in thickness direction, a grating surface including at least:
a first periodic structure;
a second periodic structure formed at a position adjacent to said first periodic structure in one of directions orthogonal to a periodic direction of said first periodic structure in such a manner that there is a phase difference of 90° with respect to said first periodic structure;
a third periodic structure formed at a position which is adjacent to said first periodic structure in said one of directions orthogonal to said periodic direction of said first periodic structure and also adjacent to said second periodic structure in said periodic direction of said first periodic structure, in such a manner that there is a phase difference of 90° with respect to said first periodic structure and a phase difference of 180° with respect to said second periodic structure;
a fourth periodic structure formed at a position which is adjacent to said first periodic structure in other direction orthogonal to said periodic direction of said first periodic structure and also opposed to said second periodic structure with said first periodic structure being interposed therebetween, in such a manner that there is a phase difference of 90° with respect to said first periodic structure and a phase difference of 180° with respect to said second periodic structure; and
a fifth periodic structure formed at a position adjacent to said first periodic structure in said other direction orthogonal to said periodic direction of said first periodic structure, which is opposed to said third periodic structure with said first periodic structure being interposed therebetween and also adjacent to said fourth periodic structure in said periodic direction of said first periodic structure, in such a manner that there is a phase difference of 90° with respect to said first periodic structure, a phase difference of 180° with respect to said third periodic structure, and a phase difference of 180° with respect to said fourth periodic structure.

11. An optical information recording and/or reproducing apparatus for performing at least either recording of information to an optical information recording medium or reproduction of information recorded to said optical information recording medium while controlling position of an objective lens by an objective lens position control device, said optical recording and/or reproducing apparatus comprising, at least:
a light source for emitting coherent light;
a diffraction structure for generating three beams by diffracting light emitted from said light source;
an objective lens that condenses said three beams generated by said diffraction structure for irradiating light spots of said three beams onto a recording face of said optical information recording medium;
a photodetector that receives and detects reflected light of said light spots of said three beams which are reflected by said optical information recording medium;
a tracking error signal detecting device for detecting a tracking error signal based on a detected result of said photodetector; and
said objective lens position control device for controlling position of said objective lens based on a detected result of said tracking error signal detecting device, wherein
said diffraction structure comprises, on at least one of surfaces in thickness direction, a grating surface including at least:
a first periodic structure;
a plurality of periodic structures from second to n-th (n: a natural number of 3 or larger, same applies hereinafter) formed in order along a periodic direction of said first periodic structure to be adjacent to each other in the periodic direction of said first periodic structure at positions adjacent to said first periodic structure in one of directions orthogonal to said periodic direction of said first periodic structure, wherein all of said second to n-th periodic structures have a phase difference of 90° with respect to said first periodic structure, and phases of said periodic structures that are adjacent in said periodic direction of said first periodic structure are different from each other by 180°; and
a plurality of periodic structures from (n+1)-th to (2n−1)-th formed in order along said periodic direction of said first periodic structure to be adjacent to each other in said periodic direction of said first periodic structure at positions adjacent to said first periodic structure in other one of directions orthogonal to said periodic direction of said first periodic structure, wherein: all of said (n+1)-th to (2n−1)-th periodic structures have a phase difference of 90° with respect to said first periodic structure, and phases of said periodic structures that are adjacent in said periodic direction of said first periodic structure are different from each other by 180°; (n+k)-th periodic structure (k: a natural number between 1 and n−1, inclusive, same applies hereinafter) of said (n+1)-th to (2n−1)-th periodic structures opposes (k+1)-th periodic structure of said (n+1)-th to (2n−1)-th periodic structures with said first periodic structure being interposed therebetween; and said (n+k)-th periodic structure has a phase difference of 180° with respect to said (k+1)-th periodic structure.

12. The optical information recording and/or reproducing apparatus according to claim 10 or 11, comprising:
as said light source, a plurality of light sources each emitting coherent light having a different wavelength from each other; and
as said diffraction structure, a plurality of diffraction structures each having said grating surface for corresponding to said coherent light emitted from said plurality of light sources.

13. The optical information recording and/or reproducing apparatus according to claim 12, wherein light spots of three beams that are generated by an arbitrary diffraction structure among said plurality of diffraction structures are irradiated onto a same track on a recording face of an optical information recording medium that is used at least either for recording or reproduction of information by said three beams.

14. The optical information recording and/or reproducing apparatus according to claim 10 or 11, wherein:
said light source is formed to selectively emit coherent first light or coherent second light having a wavelength different from that of said first light; and
said diffraction structure comprises said grating surface on one of surfaces in said thickness direction for corresponding to said first light, and comprises said grating surface on other surface in said thickness direction for corresponding to said second light.

15. The optical information recording and/or reproducing apparatus according to claim 14, wherein
light spots of three beams generated by said grating surface that corresponds to said first light are irradiated onto a same track on a recording face of a first optical information recording medium that is used at least either for recording or reproduction of information by said three beams, and
light spots of three beams generated by said grating surface that corresponds to said second light are irradiated onto a same track on a recording face of a second optical information recording medium that is used at least either for recording or reproduction of information by said three beams.
